(19) United States
(12) Patent Application Publication
(10) Pub. No.: US 2016/0299676 A1
(43) Pub. Date: Oct. 13, 2016

(54) DISPLAY APPARATUS AND METHOD FOR CONTROLLING THE SAME

(71) Applicant: SAMSUNG ELECTRONICS CO., LTD., Suwon-si (KR)

(72) Inventors: Yeo-ri YOON, Suwon-si (KR); Byung-jeong JEON, Ansan-si (KR); Hyeon-ji LEE, Seoul (KR)

(73) Assignee: SAMSUNG ELECTRONICS CO., LTD., Suwon-si (KR)

(21) Appl. No.: 15/092,722

(22) Filed: Apr. 7, 2016

Related U.S. Application Data
(60) Provisional application No. 62/144,482, filed on Apr. 8, 2015.

(30) Foreign Application Priority Data
Sep. 11, 2015 (KR) 10-2015-0128850

(51) Int. Cl. G06F 3/0484; G06F 3/14; G06F 3/0481

(52) U.S. Cl. CPC G06F 3/04847; G06F 3/04817; G06F 3/1454

(57) ABSTRACT

A display apparatus and a method for controlling the same are provided. The method for controlling the display apparatus includes establishing connection with a plurality of user terminals, receiving, in response to establishing the connections, shared data from at least one user terminal among the plurality of user terminals, displaying content related to the shared data received from the at least one user terminal in a User Interface (UI), and editing the content according to a user command.

### CROSS-REFERENCE TO RELATED APPLICATIONS

This application claims priority under 35 U.S.C. §119 from Korean Patent Application No. 10-2015-0128850, filed on Sep. 11, 2015, in the Korean Intellectual Property Office, and the benefit of U.S. Provisional Application No. 62/144,482, filed on Apr. 8, 2015, in the United States Patent and Trademark Office, the disclosures of which are incorporated herein by reference in their entireties.

### BACKGROUND

1. Field

Method and apparatus consistent with exemplary embodiments relate to a display apparatus and a method for controlling the same, and more particularly, to a display apparatus having a large-screen display, such as an electronic blackboard and a method for controlling the same.

2. Description of the Related Art

In general, a display apparatus, such as an electronic blackboard, performs an interaction operation, for example, displaying information received from a user or pre-stored content through a display screen. In recent years, the display apparatus is able to interact with an adjacent apparatus capable of performing data communication with the display apparatus to receive and display content from the adjacent apparatus.

However, the display apparatus, such as an electronic blackboard, is commonly used at a place where users have lively communication, such as a classroom or a conference room. In this regard, it is difficult to use the display apparatus to establish various community environments for users.

### SUMMARY

The present disclosure has been provided to address the aforementioned and other problems and disadvantages occurring in the related art, and an aspect of the present disclosure provides a display apparatus, such as an electronic blackboard, which may establish various community environments for users. However, aspects of the present disclosure are not required to address the aforementioned problems, and an aspect may not address the aforementioned problems.

According to an aspect of an exemplary embodiment, there is provided a method for controlling a display apparatus. The method includes establishing connection with a plurality of user terminals, receiving, in response to establishing the connections with the plurality of user terminals being performed, shared data from at least one user terminal among the plurality of user terminals; displaying content related to the shared data received from the at least one user terminal in a User Interface (UI) on the display of the display apparatus, and editing the content and displaying the edited content in the UI screen in response to receiving a user command.

The method may further include transmitting the UI screen including the content to the at least one user terminal. The at least one user terminal may display the UI screen including the content.

The user interface may be a community UI configured to share the content and provide a community environment.

The community UI may include a region corresponding to the at least one user terminal. The displaying may include displaying the content related to the shared data received from the at least one user terminal and user information corresponding to the at least one user terminal in the region.

The community UI may include at least one of a Poll UI, a social UI, and a Social Bookmark UI. The Poll UI is configured to allow a user to share an opinion of the user regarding the content, a Social UI is configured to share a user opinion on a preregistered subject, and a Social Bookmark UI is configured to share information on the preregistered subject.

The user interface may be a quick memo execution UI, and the quick memo execution UI is configured to share and edit a quick memo related to the shared data received from the at least one user terminal.

The quick memo execution UI may include an editing tool for editing the quick memo. The editing may include editing the quick memo included in the screen of the quick memo execution UI according to an execution command with respect to the editing tool.

The editing tool may include an arranging tool for arranging the quick memo. In response to a first execution command with respect to receiving the arranging tool, the editing includes grouping a plurality of quick memos included in the screen of the quick memo execution UI, and in response to receiving a second execution command, filtering the plurality of quick memos based on an arrangement condition corresponding to the second execution command.

The quick memo execution UI may include regions for respectively displaying a plurality of quick memos. In response to receiving a predetermined first user command, the displaying comprises displaying the plurality of quick memos in the regions included in the screen of the quick memo execution UI, and in response to receiving a predetermined second user command, grouping and displaying the plurality of quick memos displayed in the regions as a quick memo set.

The displaying may include displaying a screen of a workspace UI including a working tool for editing the content and generating a content according to a user command. In response to a user command being received while the screen of the workspace UI is displayed, the displaying may further include displaying an image content received from outside. In addition, the displaying the image content may include displaying the working tool in a certain region where the image content is displayed and deleting the working tool from the screen where the image content is displayed or bringing back and displaying the deleted working tool in the screen according to whether a user command with respect to the working tool is received within a predetermined time.

According to an aspect of an exemplary embodiment, this is provided a display apparatus including a communicator configured to receive shared data from at least one user terminal among a plurality of user terminals in communication with the display apparatus, a display configured to display a content related to the received shared data in a User Interface (UI), and a controller configured to receive a user command and, in response to receiving a user command, control the display to edit the content and display the edited content in the UI.

The controller may control the communicator to transmit the UI screen including the edited content to the at least one user terminal. The at least one user terminal may display the UI screen including the content.

The user interface may be a community UI, and the community UI may provide a community environment and display the content

The community UI may include a region corresponding to the at least one user terminal, and the controller may control the display to display the content related to the shared data received from the at least one user terminal and user information corresponding to the at least one user terminal in the region.

The community UI may include at least one of a Poll UI, a Social UI, and a Social Bookmark UI. The Poll UI is configured to allow a user to share an opinion of the user regarding the content related to the shared data received from the at least one user terminal, the Social UI is configured to share a user opinion on a preregistered subject, and the Social Bookmark UI is configured to share information on the preregistered subject.

The user interface may be a quick memo execution UI, and the quick memo execution UI is configured to share and edit a quick memo related to the shared data received from the at least one user terminal.

The quick memo execution UI comprises an editing tool for editing the quick memo, and the controller may edit the quick memo included in the screen of the quick memo execution UI according to an execution command with respect to the editing tool.

The editing tool may include an arranging tool for arranging a quick memo. The controller may group a plurality of quick memos included in the screen of the quick memo execution UI in response to receiving a first execution command with respect to the arranging tool, and may filter the plurality of quick memos based on an arrangement condition corresponding to a second execution command in response to receiving the second execution command.

The quick memo execution UI may include regions for respectively displaying the plurality of quick memos, and the controller may control the display to display the plurality of quick memos in the regions included in the screen of the quick memo execution UI in response to receiving a predetermined first user command and may group and display the plurality of quick memos displayed in the regions as a quick memo set in response to receiving a predetermined second user command.

The user interface may be a workspace UI including a working tool for editing the content and generating a content according to a user command. In response to receiving a user command being received while the workspace UI is displayed, the controller may control the display to display an image content received from outside and the working tool, and wherein the controller may control the display to delete the working tool from the screen where the image content is displayed or bring back and display the deleted working tool in the screen according to whether a user command with respect to the working tool is received within a predetermined time while the image content is displayed.

According to the above-described various aspects of the exemplary embodiments of the present disclosure, various community environments for users may be established through the display apparatus of the present disclosure.

### BRIEF DESCRIPTION OF THE DRAWINGS

The above and/or other aspects of the present disclosure will be more apparent by describing certain embodiments of the present disclosure with reference to the accompanying drawings, in which:

FIG. 1 is a block diagram illustrating a configuration of an electronic blackboard according to an exemplary embodiment;

FIG. 2 is a block diagram illustrating a structure of a display apparatus according to an exemplary embodiment;

FIG. 3 is a block diagram illustrating a detailed structure of a display apparatus according to an exemplary embodiment;

FIG. 4 is a demonstration diagram provided to describe an operation of connecting a display apparatus for data communication in a user terminal according to an exemplary embodiment;

FIG. 5 is a demonstration diagram provided to describe an operation of providing a community list of communities established in a display apparatus, in a user terminal according to an exemplary embodiment;

FIG. 6 is a demonstration diagram provided to describe an operation of displaying an initial screen UI of a display apparatus according to an exemplary embodiment;

FIG. 7 is a demonstration diagram provided to describe an operation of generating a community item in a user terminal according to an exemplary embodiment

FIG. 8 is a demonstration diagram provided to describe an operation of displaying a community UI screen regarding “Poll” in a display apparatus according to an exemplary embodiment;

FIG. 9 is a demonstration diagram provided to describe an operation of displaying a community UI screen in a user terminal according to an exemplary embodiment;

FIG. 10 is a demonstration diagram provided to describe an operation of displaying a community UI screen regarding “Social Wall” in a display apparatus according to an exemplary embodiment;

FIG. 11 is a demonstration diagram provided to describe an operation for updating a user opinion to a community item established in a “Social Wall” UI screen of a display apparatus, in a user terminal according to an exemplary embodiment;

FIG. 12 is a demonstration diagram provided to describe an operation of displaying a community UI screen regarding “Social Bookmark” in a display apparatus according to an exemplary embodiment;

FIG. 13 is a demonstration diagram provided to describe an operation for updating information on a preregistered subject to a community item established in a “Social Bookmark” UI screen of a display apparatus, in a user terminal according to an exemplary embodiment;

FIG. 14 is a first demonstration diagram provided to describe an operation of editing a quick memo in a quick memo execution UI environment of a display apparatus an exemplary embodiment;

FIG. 15 is a second demonstration diagram provided to describe an operation of editing a quick memo in a quick memo execution UI environment of a display apparatus according to an exemplary embodiment;

FIG. 16 is a third demonstration diagram provided to describe an operation of editing a quick memo in a quick memo execution UI environment of a display apparatus according to an exemplary embodiment;

FIG. 17 is a first demonstration diagram provided to describe an operation of arranging a quick memo in a quick memo execution UI environment of a display apparatus according to an exemplary embodiment;

FIG. 18 is a second demonstration diagram provided to describe an operation of arranging a quick memo in a quick memo execution UI environment of a display apparatus according to an exemplary embodiment;

FIG. 19 is a third demonstration diagram provided to describe an operation of arranging a quick memo in a quick memo execution UI environment of a display apparatus according to an exemplary embodiment;

FIG. 20 is a fourth demonstration diagram provided to describe an operation of arranging a quick memo in a quick memo execution UI environment of a display apparatus according to an exemplary embodiment;

FIG. 21 is a demonstration diagram provided to describe an operation of providing a workspace UI environment in a display apparatus according to an exemplary embodiment;

FIG. 22 is a first demonstration diagram provided to describe an operation of providing a working tool of a workspace UI in an external source input environment of a display apparatus according to an exemplary embodiment;

FIG. 23 is a second demonstration diagram provided to describe an operation of providing a working tool of a workspace UI in an external source input environment of a display apparatus according to an exemplary embodiment;

FIG. 24 is a demonstration diagram provided to describe an operation of providing a board writing execution UI environment in a display apparatus according to an exemplary embodiment;

FIG. 25 is a demonstration diagram provided to describe an operation of providing an office UI environment in a display apparatus according to an exemplary embodiment;

FIG. 26 is a demonstration diagram provided to describe an operation of providing a picture board UI environment in a display apparatus according to an exemplary embodiment;

FIG. 27 is a demonstration diagram provided to describe an operation of providing a note UI environment in a display apparatus according to an exemplary embodiment;

FIG. 28 is a demonstration diagram provided to describe an operation of providing a UI environment for user participation in a display apparatus according to an exemplary embodiment;

FIG. 29 is a flowchart provided to describe a method for connecting a display apparatus for data communication in a user terminal according to an exemplary embodiment; and

FIG. 30 is a flowchart provided to describe a method for controlling a display apparatus having a large-screen display according to an exemplary embodiment.

### DETAILED DESCRIPTION OF EXEMPLARY EMBODIMENTS

The description method of the present disclosure and accompanying drawings is elucidated in advance of presenting the detailed embodiments of the present disclosure.

Terms used in the following descriptions and claims are common expressions selected by considering functions in various embodiments of the present disclosure. However, such terms may vary depending upon an intention of a person having ordinary skill in the art, legal/technical interpretation, or advent of new technology. In addition, some of the terms were selected arbitrarily by an applicant. The terms may be interpreted as defined herein, and unless otherwise defined, may be interpreted based on overall descriptions of the present disclosure and common technical knowledge in the art.

In the following description, like drawing reference numerals and symbols refer to the like elements which perform the same function substantially, even in different drawings, for convenience in explanation and for better understanding. That is, although a plurality of drawings share elements having the same reference numerals, the plurality of drawings do not relate to one embodiment.

In the following descriptions and claims, a term including an ordinal, such as, “first,” “second,” etc., may be used to distinguish elements. The ordinal is used to distinguish the same or similar elements and does not limit the meaning of the term. For instance, ordinals do not affect an order of use or an order of arrangement of elements expressed with the ordinals. Respective ordinals may be replaced with each other.

A term in a singular form includes a plural form unless it is intentionally written that way. In addition, in the following descriptions, the terms “include” and “have” refer to the disclosed feature, number, step, operation, element, part, or combination thereof and are not intended to exclude any possibilities of existence or addition of one or more other features, numbers, steps, operations, elements, parts or combination thereof.

In the following descriptions, the terms “module,” “unit,” and “part” refer to an element which performs at least one function or operation. The element may be realized as hardware, software, or combination thereof. In addition, a plurality of “modules,” “units,” and “parts” may be integrated into at least one module or chip such that it is realized as at least one processor except for a case where respective “modules,” “units,” and “parts” need to be realized as discrete specific hardware.

When it is described that one part is connected to another part, the connection includes a direct connection between the parts and an indirection connection through other medium. In addition, the description that a certain part includes an element signifies that the part may further include other elements rather than signifying that the part excludes other elements, unless otherwise described.

Certain embodiments are described in greater detail below with reference to the accompanying drawings.

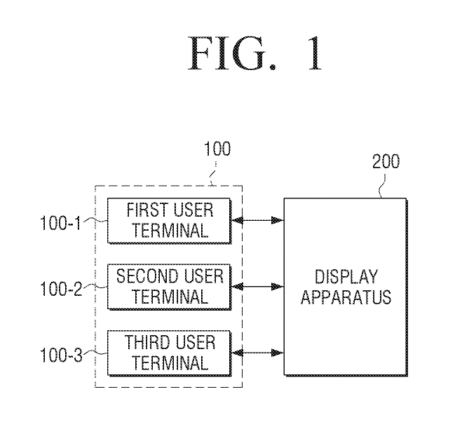

FIG. 1 is a block diagram illustrating a configuration of an electronic blackboard according to an exemplary embodiment.

As illustrated in FIG. 1, an electronic blackboard system includes a plurality of user terminals 100 and a display apparatus 200.

In this case, the plurality of user terminals 100 refer to a terminal capable of performing data communication with the display apparatus 200. The plurality of user terminals 100 may include first to third user terminals 100-1 to 100-3. The first to third user terminals 100-1 to 100-3 may be a terminal apparatus, such as a smart phone, a tablet Personal Computer (PC), a PC, etc. The display apparatus 200 having a large-screen display may be an electronic blackboard used in a classroom or a conference room where various community environments are established for a plurality of users. The display apparatus 200 may display content related to data received from at least one of the first to third user terminals 100-1 to 100-3 in a user interface (UI) screen or transmit the UI screen to at least one of the first to third user terminals 100-1 to 100-3.

The display apparatus 200 may edit the content based on a control command received from a user in connection with the content displayed in the UI screen or a user command received from at least one of the first to third user terminals 100-1 to 100-3 and display the edited content in the UI screen.

Hereinafter, the display apparatus 200 will be described in greater detail.

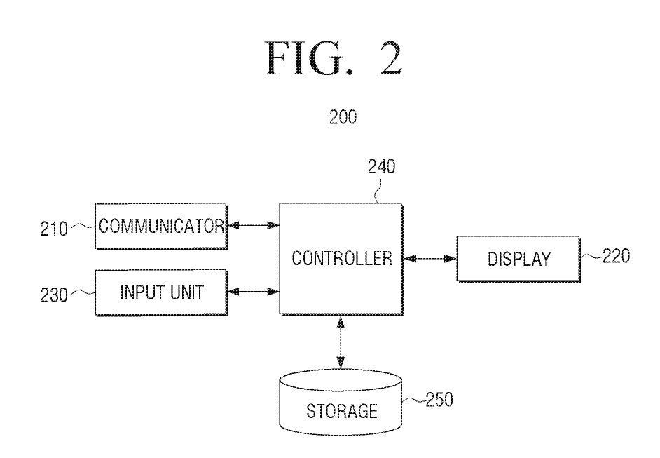

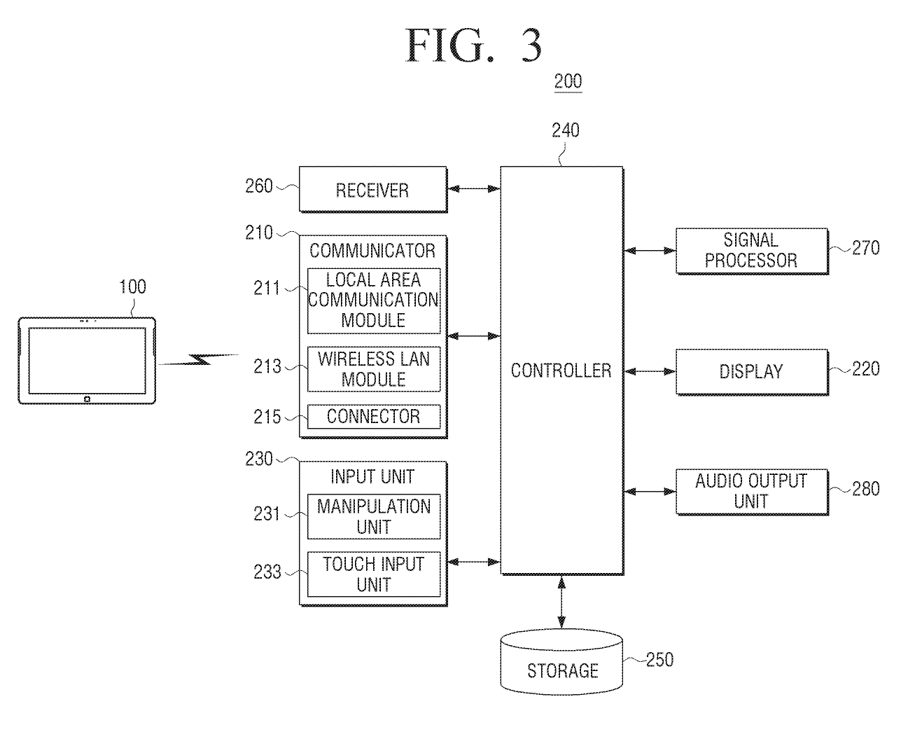

FIG. 2 is a block diagram illustrating a structure of a display apparatus according to an exemplary embodiment, and FIG. 3 is a block diagram illustrating a detailed structure of a display apparatus according to an exemplary embodiment.

As illustrated in FIG. 2, the display apparatus 200 includes a communicator 210, a display 220, an input unit 230, a controller 240, and a storage 250.

The communicator 210 performs data communication with the plurality of user terminals 100 on the same network in a wired and/or wireless manner. Accordingly, the communicator 210 may receive shared data from at least one user terminal 100 among the user terminals 100. In this case, the user terminal 100 may be a smart phone, a tablet PC, a PC, etc.

As illustrated in FIG. 3, the communicator 210 that performs the data communication with the plurality of user terminals 100 may include a local area communication module 211, a wireless Local Area Network (LAN) module 213, and a connector 215 including at least one of wired communication modules, such as High-Definition Multimedia Interface (HDMI), Universal Serial Bus (USB), Institute of Electrical and Electronics Engineers (IEEE) 1394, etc.

The local area communication module 211 performs local area communication between the display apparatus 200 and the plurality of user terminals 100 in a wireless manner. The local area communication module 211 may include at least one of a Bluetooth module, a Near Field Communication (NFC) module, a Wireless-Fidelity (Wi-Fi) module, and a Zigbee module.

The wireless LAN module 213 is connected to an external network according to a wireless communication protocol, such as, IEEE, to perform communication. In addition, the wireless communication module may further include a mobile communication module that performs communication by accessing a mobile communication network according to diverse mobile communication standards, such as 3rd Generation (3G), 3rd Generation Partnership Project (3GPP), Long Term Evolution (LTE), etc.

As described above, the communicator 210 may be realized according to the above-described various local area communication methods and may employ another communication method that is not mentioned herein according to actual demands.

The connector 215 provides an interface with respect to diverse peripherals, for example, USB 2.0, USB 3.0, HDMI, IEEE 1394, etc. The connector 215 may receive data related to an image content from an adjacent apparatus including the plurality of user terminals 100 through a wired cable connected to the connector 215 according to a control command of the controller 240. Further, the connector 215 may be supplied with power from a power source through a wired cable physically connected to the connector 215.

The display 220 displays content related to shared data received from at least one user terminal 100 among the plurality of user terminals 100 in a UI screen. In addition, the display 220 displays an image content received from an external source, such as a content server, and an image-processed by the controller 240. The display 220 may be realized as Liquid Crystal Display (LCD), Organic Light-Emitting Diode (OLED), Plasma Display Panel (PDP), etc. When the input unit 230 is realized as a touch pad, the display 220 may be realized as a touch screen which forms a mutual layer structure with the input unit 230. The detailed description on the input unit 230 will be provided below.

The input unit 230 is an input means for receiving various user commands and transmitting the received user commands to the controller 240. As illustrated in FIG. 3, the input unit 230 may include a manipulation unit 231 and a touch input unit 233 for receiving a user touch command. In this embodiment, the manipulation unit 231 may be realized as a key pad having diverse functions keys, number keys, special keys, letter keys, etc. Furthermore, a user may input a user command by using gestures. Therefore, the manipulation unit 231 may be realized as a motion sensor capable of sensing a gesture of the user. When the display 220 is realized as a touch screen, the touch input unit 233 may be realized as a touch pad that forms a mutual layer structure with the display 220.

The controller 240 controls overall operations of components of the display apparatus 200. Specially, in response to receiving shared data from at least one user terminal among the plurality of user terminals 100, the controller 240 controls the display 220 to display a content related to the received shared data in a UI screen. Further, the controller 240 controls the display 220 to edit the content displayed in the UI screen and display the edited content in the UI screen according to a user command input through the input unit 230. In addition, the controller 240 controls the communicator 210 to transmit the UI screen including the edited content to the at least one user terminal 100. Accordingly, the communicator 210 may transmit the UI screen including the edited content to the at least one user terminal 100. The user terminal 100 may display the UI screen received from the display apparatus 200.

The storage 250 may store at least one of the shared data received from at least one user terminal among the plurality of user terminals 100, the content related to the shared data, and a content generated according to a user command inputted through the input unit 230. Further, the storage 250 may store an Operating System (OS) program for controlling the operations of the display apparatus 200 and an application program managed by the OS program, performs the operations of the display apparatus 200 by using resource of the OS program, and provides a UI. In this exemplary embodiment, the OS program may be a program read from the storage 250 and compiled to operate the components of the display apparatus 200 in response to the display apparatus 200 being turned on.

The storage 250 may also store diverse multimedia data processed by the controller 240, a content, and an image content received from an external source. The storage 250 may be realized as at least one of a Read-Only Memory (ROM), a Random Access Memory (RAM), a memory card being detachable to the display apparatus 200 (for example, a Secure Digital (SD) card, a memory stick, etc.), a non-volatile memory, a volatile memory, a Hard Disk Drive (HDD), and a Solid State Drive (SSD).

As illustrated in FIG. 3, the display apparatus 200 may further include a receiver 260, an signal processor 270, and an audio output unit 280, in addition to the above-described communicator 210, display 220, input unit 230, controller 240, and storage 250.

The receiver 260 may include an Infrared Rays (IR) receiver for receiving a user command transmitted from a remote controller which controls the operations of the display apparatus 200. To be specific, the remote controller may transmit a user command, for example, a command to set a function of the display apparatus 200, to the display apparatus 200 through a control signal, such as an IR signal, a Radio Frequency (RF) signal, etc. Accordingly, the receiver 260 may receive a user command, such as a command to set a function of the display apparatus 200, based on the control signal received from the remote controller through the IR receiver. In addition, the receiver 260 may include a tuner for receiving a broadcast signal of a broadcast channel selected by a user from a plurality of image contents provided from a broadcasting server. In this embodiment, in response to a channel tune command being received through the remote controller, the receiver 260 may tune a channel corresponding to the channel tune command received from the remote controller through the tuner and receive a broadcast signal through the tuned channel.

The image processor 270 processes a broadcast signal of a broadcast channel received through the receiver 260 or data received from an adjacent apparatus, such as one of the plurality of user terminals 100, through the communicator 210 to transform the broadcast signal/data into a form that may be output.

The audio output unit 280 outputs audio data processed by the signal processor 270 as an audio signal through a speaker. The display 220 may display image data processed by the image processor 270 in a screen.

As described above, in response to the shared data being received from at least one user terminal among the plurality of user terminals 100, the controller 240 controls the display 220 to display content related to the received shared data in a UI screen. In addition, the controller 240 controls the display 220 to edit the content displayed in the UI screen and display the edited content in the UI screen according to a user command input through the input unit 230.

According to an embodiment, a UI screen displayed through the display 220 may be a community UI screen for sharing a content and providing a community environment.

To be specific, in response to a user command being received from at least one user terminal among the plurality of user terminals 100, the controller 240 generates a community UI screen for sharing content and providing a community environment. Subsequently, the controller 240 controls the display 220 to display the content related to the shared data received from the at least one user terminal 100 in the screen of the community UI.

In this exemplary embodiment, the community UI may include a region corresponding to the at least one user terminal 100. Accordingly, the controller 240 may control the display 220 to display the content related to the received shared data and user information in the region corresponding to the at least one user terminal 100.

Accordingly, the display 220 may display the content related to the shared data and the user information in the region corresponding to the user terminal 100 that transmitted the shared data among a plurality of regions included in the community UI.

In response to a user command being received while the content is displayed in a certain region among the plurality of regions of the community UI, the controller 240 controls the display 220 to edit the content and display the edited content in the community UI screen. Accordingly, the display 220 may display the edited content in a region where the content is displayed among the plurality of regions included in the community UI.

Meanwhile, the community UI may include at least one of a Poll UI for user participation on the content related to the shared data received from the at least one user terminal 100, a Social UI for sharing a user opinion on a preregistered subject, and a Social Bookmark UI for sharing information on a preregistered subject.

According to an exemplary embodiment, a UI screen displayed through the display 220 may be a quick memo execution UI screen.

To be specific, in response to a user command being received from the at least one user terminal among the plurality of user terminals 100, the controller 240 generates a quick memo execution UI screen for sharing and editing a quick memo related to the shared data received from the at least one user terminal 100. Subsequently, the controller 240 controls the display 220 to display the generated quick memo execution UI. In this exemplary embodiment, the quick memo execution UI includes an editing tool for editing a quick memo. Accordingly, the display 220 may display a quick memo related to the shared data received from the at least one user terminal 100, the editing tool for editing the quick memo, and user information in the quick memo execution UI screen.

In response to a user command with respect to the editing tool being received while the quick memo execution UI is displayed, the controller 240 may control the display 220 to edit the quick memo displayed in the quick memo execution UI screen and display the edited quick memo. Accordingly, the display 220 may display the quick memo edited by a quick memo tool in the quick memo execution UI screen.

The editing tool for editing a quick memo may include an arranging tool for arranging a quick memo. Accordingly, in response to receiving a first execution command among execution commands with respect to the arranging tool included in the editing tool, the controller 240 may group a plurality of quick memos included in the quick memo execution UI screen. In addition, in response to receiving a second execution command, the controller 240 may filter the plurality of quick memos based on an arrangement condition corresponding to the second execution command. Accordingly, the display 220 may display grouped quick memos or filtered quick memos among the plurality of quick memos in the quick memo execution UI screen.

According to an exemplary embodiment, a UI screen displayed through the display 220 may be a workspace UI screen.

To be specific, in response to a user command being received, the controller 240 generates a workspace UI including a working tool for editing the content related to the shared data received from the at least one user terminal 100 or generating a new content. Subsequently, the controller 240 controls the display 220 to display the generated workspace UI. In response to a user command being received while the workspace UI screen is displayed through the display 220, the controller 240 controls the display 220 to display an image content received from outside and the working tool included in the workspace UI based on the control command. According to the control command, the display 220 may display the working tool for performing at least one of an operation of editing a content and an operation of generating a content in a certain region where the image content is displayed while displaying the image content received from outside.

The controller 240 determines whether a user command with respect to the working tool displayed in the region where the image content is displayed is received within a predetermined time, while the image content is displayed. In response to determining that a user command with respect to the working tool is not received within the predetermined time, the controller 240 controls the display 220 to delete the working tool displayed in the screen where the image content is displayed. In response to a user command being received in a state in which the working tool has been deleted, the controller 240 controls the display 220 to bring back and display the deleted working tool in the screen. According to the control command, the display 220 may display an image content including the working tool or display an image content from which the working tool has been deleted.

Thus far, the components of the display apparatus 200 have been described in detail. As the display apparatus 200, the user terminal 100 may perform data communication with an adjacent terminal to transmit/receive an image content, edit the image content, and display the image content according to a user command. Accordingly, the components of the user terminal 100 are similar or correspond to the components of the display apparatus 200, and thus, the detailed descriptions on the components of the user terminal 100 are omitted.

Hereinafter, the operations of the user terminal 100 and the display apparatus 200 will be described in greater detail according to various embodiments.

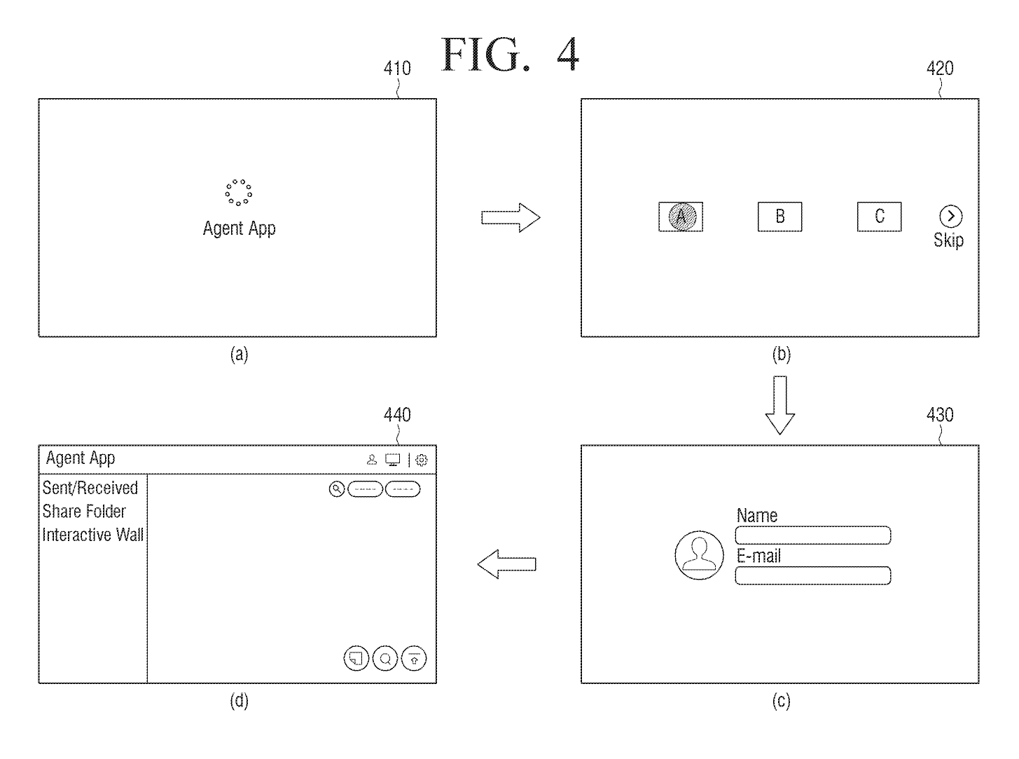

FIG. 4 is a demonstration diagram provided to describe an operation of connecting a display apparatus for data communication in a user terminal according to an exemplary embodiment.

As illustrated in FIG. 4(a), the user terminal 100 executes an “Agent App”-related application 410 for performing data communication with the display apparatus 200 according to a user command. In response to the “Agent App”-related application being executed, the user terminal 100 searches for the display apparatus 200 capable of performing the data communication with the user terminal 100 and displays a list UI screen 420 regarding the searched display apparatuses A to C 200, as illustrated in FIG. 4(b). In response to a selection command with respect to the display apparatus A 200 being received while the list UI screen is displayed, the user terminal 100 displays a user authentication UI screen 430 for use authentication, as illustrated in FIG. 4(c). According to an embodiment, the user terminal 100 may display the user authentication UI screen for inputting a user's name and e-mail information.

In response to the user's name and e-mail information being received from a user while the user authentication UI screen is displayed, the user terminal 100 may display an “Agent App” application execution UI screen 440 for performing data communication with the display apparatus A 200 selected by the user, as illustrated in FIG. 4(d).

In response to the “Agent App” application execution UI screen 440 being displayed, the user may transmit shared data to the display apparatus A 200 through his/her own user terminal 100 or receive and display a UI screen including a content related to the shared data transmitted to the display apparatus A 200 by another user's user terminal 100.

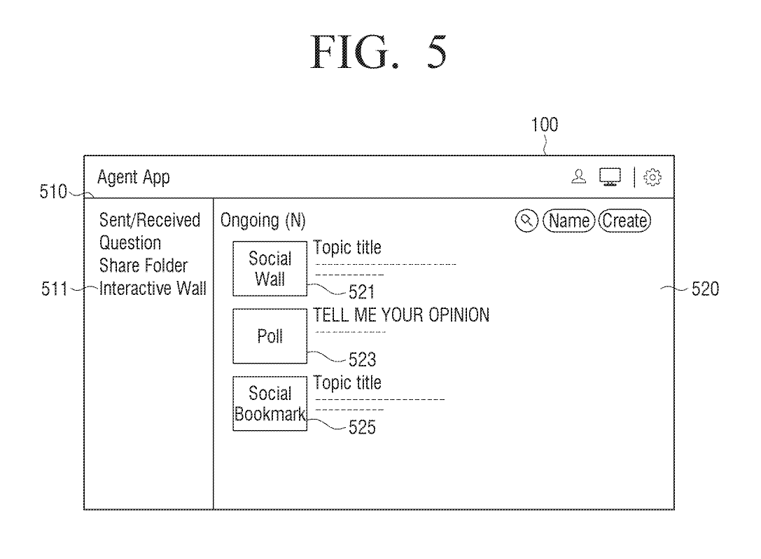

FIG. 5 is a demonstration diagram provided to describe an operation of providing a community list of communities established in a display apparatus, in a user terminal according to an exemplary embodiment.

As described above in connection with FIG. 4, in response to the “Agent App” application execution UI screen 440 being displayed, the user terminal 100 may provide a community list of communities established in the display apparatus 200 according to a user request.

To be specific, as illustrated in FIG. 5, in response to the “Agent App” application execution UI screen 440 being displayed, the user terminal 100 may display a menu list 510 for transmitting shared data to or receiving shared data from the display apparatus 200 or providing the community list of the communities established in the display apparatus 200 in a certain region of the “Agent App” application execution UI screen 440. In response to an “Interactive Wall” menu 511 for providing the community list of the communities established in the display apparatus 200 being selected while the menu list 510 is displayed, the user terminal 100 may receive and display a community list 520 of the communities established in the display apparatus 200 from the display apparatus 200 connected to the user terminal 100.

As illustrated in FIG. 5, the user terminal 100 may display the community list 520 including a Social Wall 521, a Poll 523, a Social Bookmark 525 currently established in the display apparatus 200. In this case, the Social Wall 521 may be a community item established to share a user opinion on a preregistered subject, the Poll 523 may be a community item established to share a user opinion on a content requested by another user, and the Social Bookmark 525 may be a community item established to share information on a preregistered subject.

Accordingly, the user may select a community item in which the user wishes to participate from the community list 520 displayed in the user terminal 100 and input a user opinion on a preregistered subject or content in connection with the selected community item or input information on the preregistered subject.

In response to the user opinion on the preregistered subject or content or information on the preregistered subject being input in connection with the selected community item, the user terminal 100 transmits the user opinion or information inputted in connection with the community item to the display apparatus 200. For example, the user may select a community item regarding the Social Wall 521 and input a user opinion on a preregistered subject in connection with the Social Wall 521. In this case, the user terminal 100 transmits identification information and the user opinion on the community item regarding the Social Wall 521 selected by the user to the display apparatus 200.

Accordingly, the display apparatus 200 may update the user opinion to the community item regarding the Social Wall 521 selected by the user based on the identification information received from the user terminal 100. Other users who participated in the community item regarding the Social Wall 521 may check the updated community item regarding the Social Wall 521 through the user terminal 100 or display apparatus 200.

The user terminal 100, which displays the community list 520 of the communities established in the display apparatus 200, may generate a community item requested by the user and transmit a request for establishment of the generated community item to the display apparatus 200 according to a user request. The operation of generating a community item corresponding to a user request in the user terminal 100 will be described below in further detail.

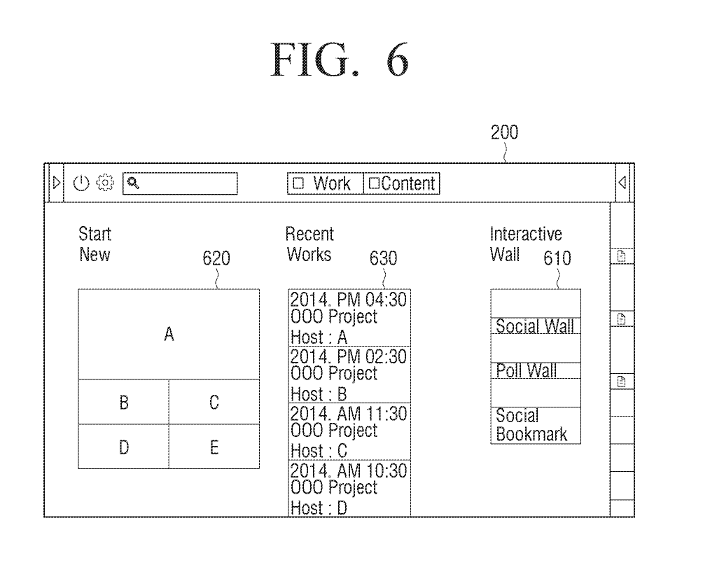

FIG. 6 is a demonstration diagram provided to describe an operation of displaying an initial screen UI of a display apparatus according to an exemplary embodiment.

As illustrated in FIG. 6, the display apparatus 200 may display an initial screen UI. As illustrated, the initial screen UI may be divided into three regions.

A first region 610 provides a list of items currently established to participate in a community. To be specific, the first region 610, which provides a list of items being currently established to participate in a community, may include a “Social Wall” community item established to share a user opinion on a preregistered subject, a “Poll” community item established to share user opinions of a plurality of users in connection with a user-requested content, and a “Social Bookmark” community item established to share information on a preregistered subject.

Accordingly, in response to one of the community items in the first region 610 being selected, the display apparatus 200 may provide a UI screen corresponding to the selected community item.

A second region 620 provides a list of workspace items for providing a working environment for each category. In response to one of the workspace items A to E in the second region 620 being selected, the display apparatus 200 may provide a UI screen corresponding to the selected workspace item.

A third region 630 may be a region that provides a list including previously established community items of which community activity has been finished, but not limited thereto. The third region 630 may provide a list including the community items of which community activity has been finished and workspace items which were previously provided. Meanwhile, each item included in the list of the third region 630 may include at least one of time information on an established time and closed time of a community UI, community subject information, and user information who established a community UI, for each item.

Accordingly, the user may check a state of the previous community activity based on the items in the third region 630 of the display apparatus 200.

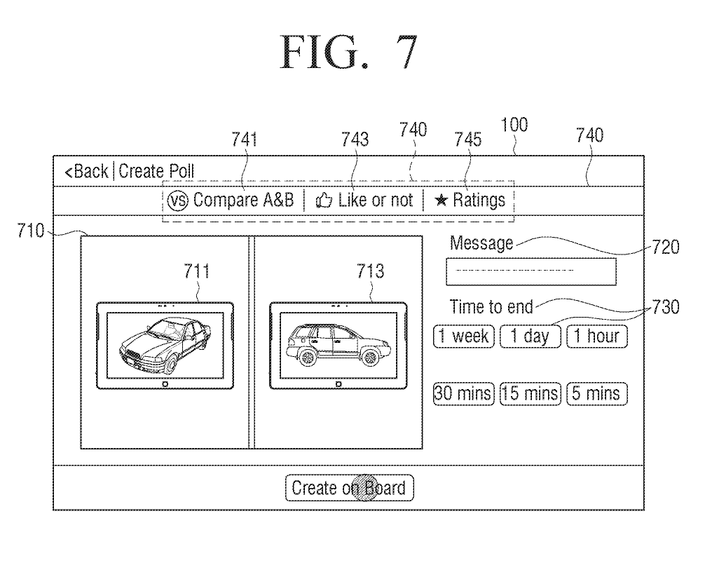

FIG. 7 is a demonstration diagram provided to describe an operation of generating a community item in a user terminal according to an exemplary embodiment.

As illustrated above in connection with FIG. 5, in response to the “Interactive Wall” menu 511 for providing the community list of the communities established in the display apparatus 200 being selected while the “Agent App” application execution UI screen is displayed, the user terminal 100 may display a UI screen including the community list 520 of the communities established in the display apparatus 200 and an icon for establishing a community item, from the display apparatus 200 connected to the user terminal 100. In response to a selection command with respect to the icon for establishing a community item being received and then a selection command with respect to one of the plurality of community items being received while the UI screen is displayed, the user terminal 100 displays a UI screen for establishing a community item, the screen corresponding to the received selection command.

As illustrated in FIG. 7, in response to a selection command with respect to a community item regarding the “Poll” among the plurality of community items being received, the user terminal 100 may display a UI screen for establishing a community item regarding the “Poll.”

The UI screen for establishing a community item regarding the “Poll” may include a first region 710 for displaying a content, a second region 720 for inputting a community subject regarding the content displayed in the first region 710, a third region 730 for setting an establishment period of the community item regarding the “Poll”, and a fourth region 740 for setting a selection type regarding the content.

To be specific, while the UI screen for establishing the community item regarding the “Poll” is displayed, the user terminal 100 may display Image A 711 and Image B 713 in the first region 710 and display a text message for inquiring user preference on the Image A 711 and Image B 713 in the second region 720 according to a user command. In addition, the user terminal 100 may receive a selection command with respect to a first icon representing “1 day” among a plurality of icons for selecting the establishment period of the community item regarding the “Poll” displayed in the third region 730 and a selection command regarding a first selection type among first to third selection types 741 to 745 displayed in the fourth region 740. Subsequently, in response to an establishment command with respect to the community item regarding the “Poll” being received, the user terminal 100 may transmit shared data related to the community item on the Image A 711 and Images B 713 to the display apparatus 200 in order to request for establishment of the community item.

In response to receiving the request for establishment of the community item, the display apparatus 200 may establish a new community item in the “Poll” UI screen and display the content related to the shared data received from the user terminal 100 in the established community item.

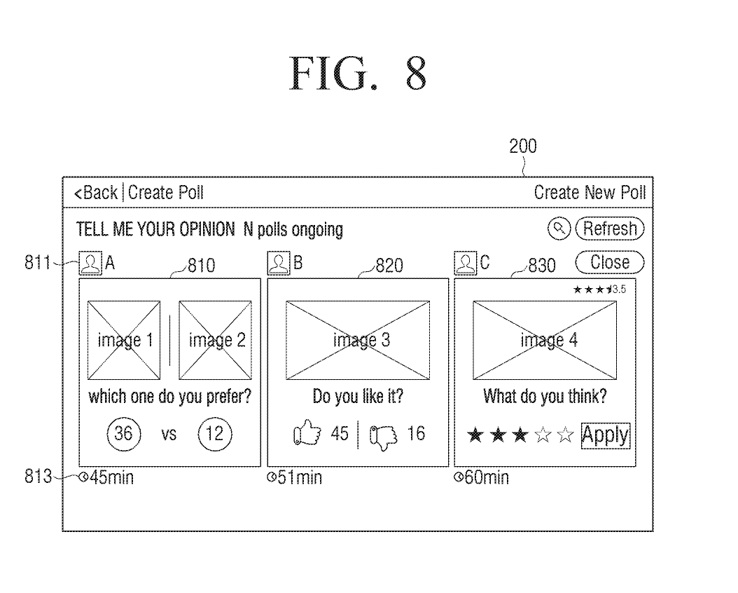

FIG. 8 is a demonstration diagram provided to describe an operation of displaying a community UI screen regarding “Poll” in a display apparatus according to an exemplary embodiment.

As described above in connection with FIG. 7, in response to the request for establishment of the community item regarding the “Poll” being received from the user terminal 100, the display apparatus 200 may establish a new community item 810 (hereinafter referred to as “first community item”) in the “Poll” UI screen and display the established first community item 810 and community items 820, 830 which were previously established. In this case, the display apparatus 200 may display the first to third community items 810 to 830 in the “Poll” UI screen based on an order that each of the first to third community items 810 to 830 was generated.

However, this embodiment is not limited thereto. The display apparatus 200 may calculate a remaining time that each of the first to third community items 810 to 830 may be displayed in the “Poll” UI screen based on the establishment period of each community item and display the first to third community items 810 to 830 in the “Poll” UI screen based on the calculated remaining time.

The first to third community items 810 to 830 displayed in the “Poll” UI screen may be a content generated based on the shared data received from the user terminal 100. As described above in conjunction with FIG. 7, in response to the shared data being received from the user terminal 100, the display apparatus 200 generates the first community item 810 in a region corresponding to the user terminal 100. Subsequently, the display apparatus 200 displays a content including the images 1 and 2 and a text message for inquiring the user preference on the images 1 and 2 in the first community item 810 generated based on the received shared data. In addition, the display apparatus 200 may display user information 811 on a user who requested for establishment of the first community item 810 and an icon 813 representing the establishment period of the first community item 810 in an upper part and/or a lower part of the first community item 810 established based on the received shared data.

In response to a selection command with respect to one of the images 1 and 2 included in the content of the first community item 810 being received from a plurality of users while the first community item 810 is established, the display apparatus 200 may display a content including selection state information in a form of a predetermined first selection type based on the received shared data.

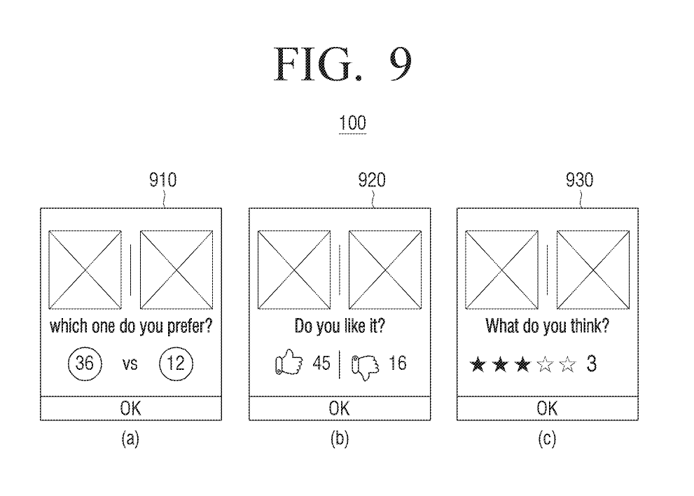

FIG. 9 is a demonstration diagram provided to describe an operation of displaying a community UI screen in a user terminal according to an exemplary embodiment.

The user terminal 100 may display a community item established in the community UI screen of the display apparatus 200 according to a user's request of or a community item established in the community UI of the display apparatus 200 according to another user's request.

As illustrated in FIG. 9(a) the user terminal 100 may display a community item 910 which provides a selection result selected by a plurality of users in connection with the images 1 and 2 in a form of the first selection type. In addition, as illustrated in FIG. 9(b), the user terminal 100 may display a community item 920 which provides a selection result selected by the plurality of users in connection with the images 1 and 2 in a form of a second selection type. In addition, as illustrated in FIG. 9(c), the user terminal 100 may display the community item 920, which provides a selection result selected by the plurality of users in connection with the images 1 and 2 in a form of a third selection type.

As described above, the user terminal 100 which displays a community item established in a community screen of the display apparatus 200 may receive and display the community item established in the community screen of the display apparatus 200 according to a user's request. Alternatively, in response to the selection result selected by the plurality of users in connection with the images 1 and 2 being updated, the user terminal 100 may receive and display the updated community item from the display apparatus 200.

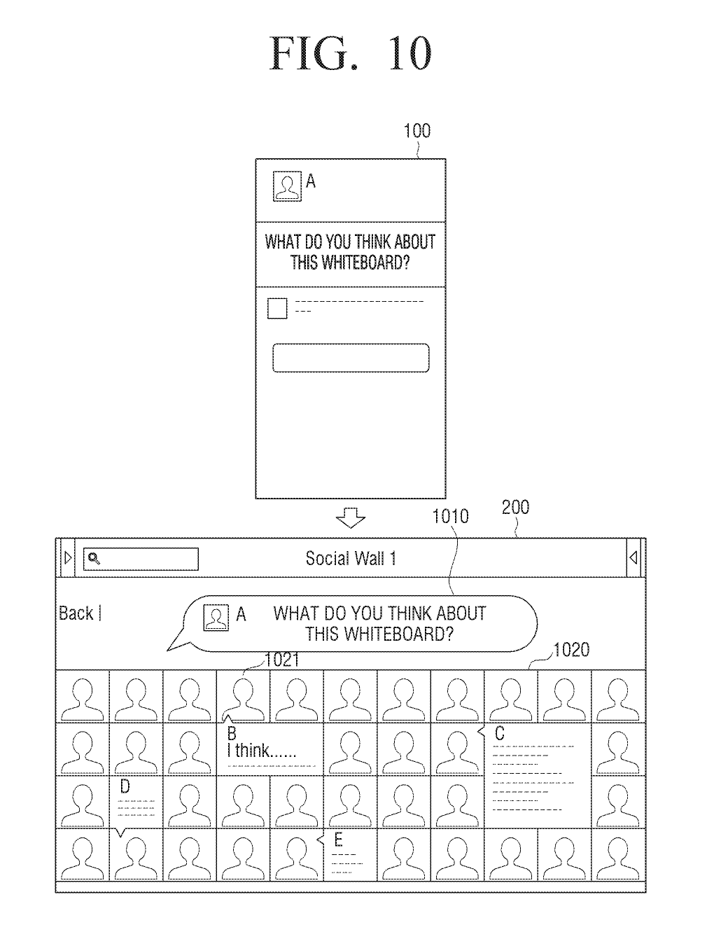

FIG. 10 is a demonstration diagram provided to describe an operation of displaying a community UI screen regarding “Social Wall” in a display apparatus according to an exemplary embodiment.

As illustrated in FIG. 10, the user terminal 100 may transmit shared data for establishing a community item regarding the “Social Wall” to the display apparatus 200 according to a user command. In response to the shared data being received, the display apparatus 200 may establish a new community item 1010 in the “Social Wall” UI screen among community UIs. That is, the display apparatus 200 may establish the community item 1010 including a subject “WHAT DO YOU THINK ABOUT THIS WHITEBOARD?” and identification information on User A who established the community item 1010 in connection with the subject and display the community item 1010 in the “Social Wall” UI screen.

In response to the community item 1010 being established in the “Social Wall” UI screen, the display apparatus 20 displays user information on the plurality of users who are able to participate in connection with the subject in a certain region 1020 of the established community item 1010.

Meanwhile, in response to user-related shared data of the User B among the plurality of users being received from the user terminal 100 in connection with the subject of the community item 1010, the display apparatus 200 may display a user opinion of the User B in a sub region 1021 where user information of the User B among user information of the plurality of users displayed in the region 1020 is displayed, based on the shared data received from the user terminal 100 of the User B.

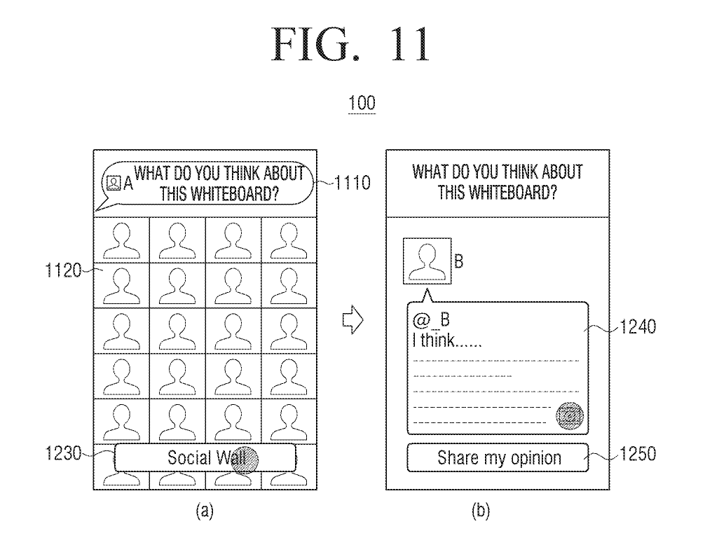

FIG. 11 is a demonstration diagram provided to describe an operation for updating a user opinion to a community item established in a “Social Wall” UI screen of a display apparatus in a user terminal according to an exemplary embodiment.

The user terminal 100 may display a UI screen regarding a community item corresponding to a user command among the plurality of community items established in the “Social Wall” UI screen of the display apparatus 200.

To be specific, as illustrated in FIG. 11(a), the user terminal 100 may display a UI screen 1110 regarding a first community item established in the “Social Wall” UI screen. In this case, the UI screen 1110 regarding the first community item may include at least one of user information on the User A who established the first community item, a subject registered by the User A, and user information on users who participated in the first community item.

In addition, the user terminal 100 may display an icon 1230 for updating a user opinion to the first community item in the UI screen 1110 regarding the first community item. Accordingly, in response to the icon 1230 for updating a user opinion being selected, the user terminal 100 displays a text input window 1240 for inputting a user opinion of the User B and an icon 1250 for transmitting the user opinion inputted into the text input window 1240 to the display apparatus 200, as illustrated in FIG. 11(b).

Accordingly, in response to a selection command with respect to the icon 1250 being received after the user opinion of the User B is inputted through the text input window 1240, the user terminal 100 transmits the shared data related to the user opinion inputted by the User B to the display apparatus 200.

As described above in connection with FIG. 10, the display apparatus may display the user opinion of the User B in the sub region 1021 where the user information on the User B among the user information on the plurality of users displayed in the region 1020 is displayed based on the shared data received from the user terminal 100 of the User B.

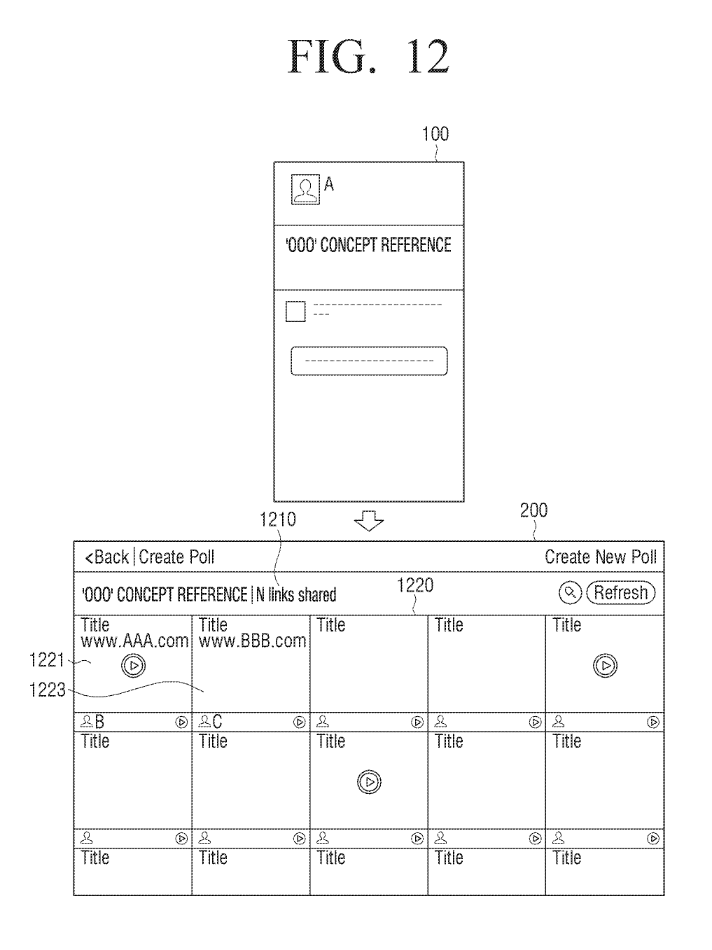

FIG. 12 is a demonstration diagram provided to describe an operation of displaying a community UI screen regarding “Social Bookmark” in a display apparatus according to an exemplary embodiment.

As illustrated in FIG. 12, the user terminal 100 may transmit the shared data for establishing a community item regarding the “Social Bookmark” to the display apparatus 200 according to a user command. In response to the shared data being received, the display apparatus 200 may establish a community item 1210 in the “Social Bookmark” UI screen among the community UIs. That is, the display apparatus 200 may establish the community item 1210 including a subject ““∘∘∘” CONCEPT REFERENCE” based on the shared data received from the user terminal 100 and display the community item 1210 in the “Social Bookmark” UI screen.

Accordingly, in connection with the community item 1210 established in the “Social Bookmark” UI screen, the plurality of users may share information related to the subject of the community item 1210. To be specific, the display apparatus 200 may receive the shared data related to the information on the subject of the community item 1210 from the user terminal 100 of the plurality of users, in connection with the community item 1210 established in the “Social Bookmark” UI screen. In response to the shared data being received from the user terminal 100 of the plurality of users, the display apparatus 200 displays the information received from the user terminal 100 of the plurality of users in connection with the subject and the user information on each of the plurality of users in a certain region 1220 of the established community item 1210.

For example, the user terminal 100 of the User B may transmit shared data including Uniform/Universal Resource Locator (URL) of a web page and a moving image related to the subject of the established community item 1210 to the display apparatus 200 according to a request of the User B, and the user terminal 100 of User C may transmit shared data including URL of a web page related to the subject of the established community item 1210 according to a request of the User C.

In this case, the display apparatus 200 may display the URL, an icon for executing the moving image, and the user information on the User B in a first sub region 1221 corresponding to the user terminal 100 of the User B who transmitted the shared data, based on the shared data received from the user terminal 100 of the User B.

In addition, the display apparatus 200 may display the URL and the user information on the User C in a second sub region 1222 corresponding to the user terminal 100 of the User C who transmitted the shared data, based on the shared data received from the user terminal 100 of the User C.

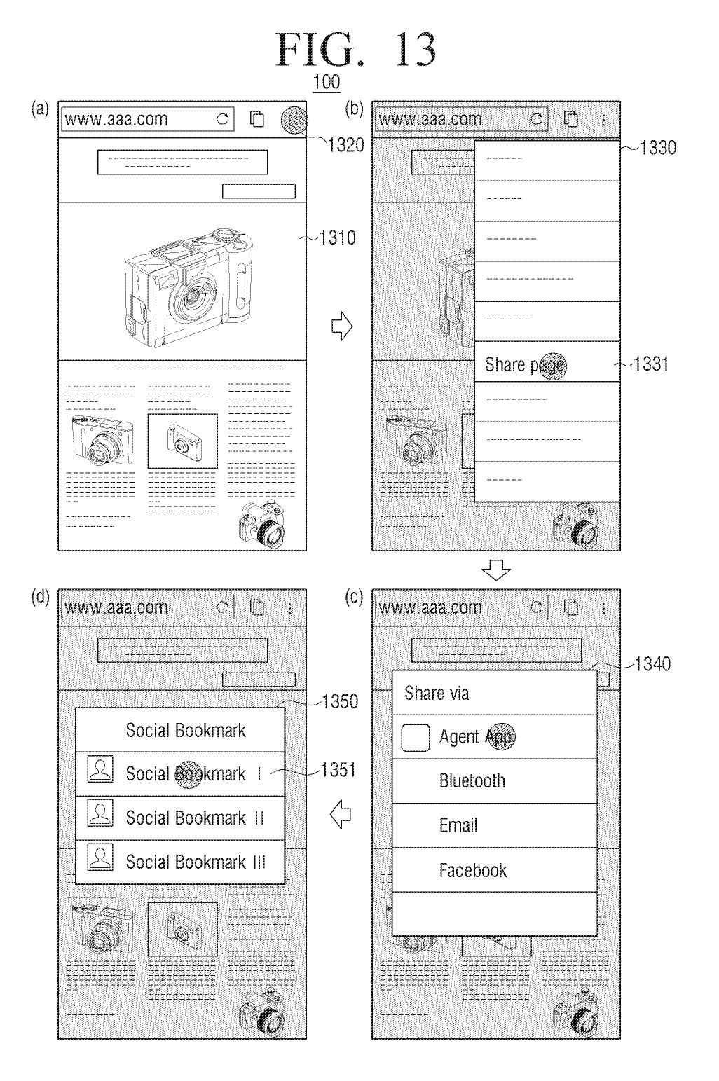

FIG. 13 is a demonstration diagram provided to describe an operation for updating information on a subject preregistered in a community item established in a “Social Bookmark” UI screen of a display apparatus in a user terminal according to an exemplary embodiment.

As illustrated in FIG. 13(b), the user terminal 100 may display a web page screen 1310 corresponding to a user request. The web page screen 1310 displayed in the user terminal 100 may be information on a subject of a community item in which the user participates among a plurality of community items established in the “Social Bookmark” UI screen of the display apparatus 200. In this case, the user may select an icon 1320 displayed in an upper part of a certain side of the web page screen 1310 in order to update information on the web page screen 1310 to the community item in which the user participates.

In response to a selection command with respect to the icon 1320 being received, the user terminal 100 displays a first list UI 1330 for selecting a sharing type with respect to the web page screen 1320 in a certain region where the web page screen 1320 is displayed, as illustrated in FIG. 13(b). In response to a sharing type 1331 regarding “Share Page” being selected while the first list UI 1330 is displayed, the user terminal 100 displays a second list UI 1340 for selecting an application for execution of a route to transmit the web page screen 1320, as illustrated in FIG. 13(c). In response to a selection command with respect to an application 1341 regarding the “Agent App” being received while the second list UI 1340 is displayed, the user terminal 100 displays a third list UI 1350 regarding the plurality of community items established in the “Social Bookmark” UI screen, as illustrated in FIG. 13(d). In response to a selection command with respect to a first community item 1351 established by the User A being received while the third list UI 1350 is displayed, the user terminal 100 generates shared data for updating the web page screen 1310 to the first community item 1351 and transmit the generated shared data to the display apparatus 200.

Accordingly, as described above in connection with FIG. 12, the display apparatus 200 may display the URL of the web page screen 1310 and the user information of a user who requested to share the web page screen 1310 in a sub region based on the shared data received from the user terminal 100.

Thus far, the operation of establishing a community item corresponding to a request of the user terminal 100 and sharing contents of a plurality of users through a community UI including the established community item in the display apparatus 200 has been described in detail.

Hereinafter, an operation of displaying a quick memo execution UI and a workspace UI screen in the display apparatus 200 according to an embodiment will be described in detail.

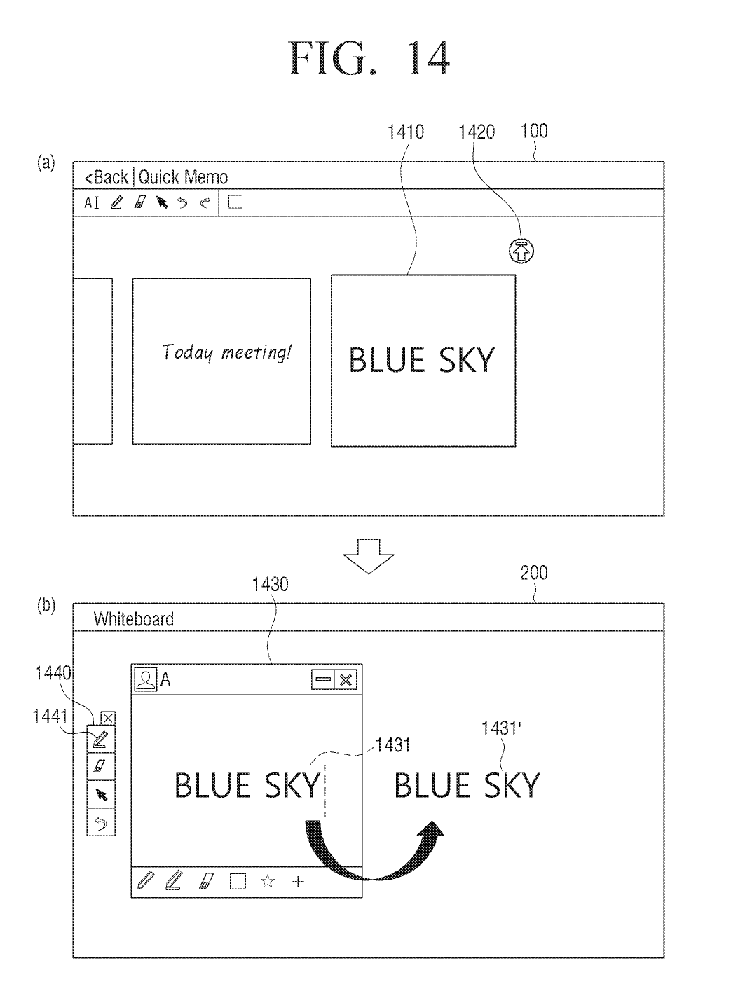

FIG. 14 is a first demonstration diagram provided to describe an operation of editing a quick memo in a quick memo execution UI environment of a display apparatus according to an exemplary embodiment.

As illustrated in FIG. 14(a), in response to text information being received according to a user command while the quick memo UI is displayed, the user terminal 100 generates a quick memo 1410 including an inputted text. The quick memo 1410 may include an icon 1420 for transmitting shared data to the display apparatus 200. Accordingly, in response to a selection command with respect to the icon 1420 included in the quick memo 1410 being received, the user terminal 100 transmits the shared data including the text displayed in the quick memo 1420 to the display apparatus 200.

In response to the shared data related to the quick memo 1410 being received from the user terminal 100, the display apparatus 200 may generate a content 1430 including a text 1431 included in the quick memo 1410 and user information of the User A who requested for transmission of the quick memo 1410 and display the generated content in the quick memo execution UI screen. In addition, the display apparatus 200 may display an editing tool 1440 for editing the text included in the content 1430 in a certain region of the quick memo execution UI screen.

While the quick memo execution UI screen is displayed, the display apparatus 200 may receive a selection command with respect to a first editing icon 1441 among a plurality of editing icons included in the editing tool 1440 and then receive a selection command with respect to a region where the text 1431 in the content 1430 is displayed. In response to a drag command being received after the selection command with respect to the text 1431 is received, the display apparatus 200 may recognize the text 1431 in the content 1430, generate a new text 1431′ corresponding to the recognized text 1430, and display the generated new text 1431′ in a region corresponding to the drag command.

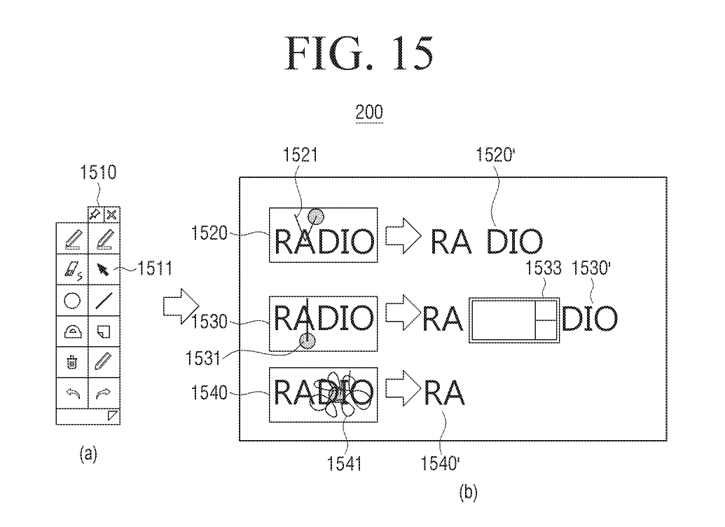

FIG. 15 is a second demonstration diagram provided to describe an operation of editing a quick memo in a quick memo execution UI environment of a display apparatus according to an embodiment.

Specifically, FIG. 15 is a demonstration diagram provided to describe an operation of displaying a quick memo execution UI screen in the display apparatus 200. As described above, the quick memo execution UI screen may include an editing tool for editing the quick memo-related content generated based on the shared data received from the user terminal 100 and the text included in the content.

Specifically, as illustrated in FIG. 15(a), in response to a selection command with respect to a first editing icon 1511 being received and then a user command with respect to the text included in a content being received, the display apparatus 200 may edit the text based on the received user command.

According to an exemplary embodiment, as illustrated in FIG. 15(b), in response to a first user command 1521 with respect to first text 1520 being received in a state in which the first editing icon 1511 has been selected, the display apparatus 200 performs an editing operation of spacing letters adjacent to pointing position of the first user command 1521 among letters constituting the first text 1520. Accordingly, the display apparatus 200 may generate an edited text 1520′ in connection with the first text 1520 and display the edited text 1520′ in the quick memo execution UI screen.

According to an exemplary embodiment, in response to a second user command 1531 with respect to second text 1530 being received in a state where the first editing icon 1511 has been selected, the display apparatus 200 performs an editing operation of generating a memo window UI 1533 for inserting a content between letters adjacent to the pointing position of the second user command 1531 among letters constituting the second text 1530. Accordingly, the display apparatus 200 may display text 1530′ being edited such that the memo window UI 1533 is inserted in connection with the second text 1530 in the quick memo execution UI screen.

According to an exemplary embodiment, in response to a third user command 1541 with respect to third text 1540 being received in a state where the first editing icon 1511 has been selected, the display apparatus 200 performs an editing operation of deleting a letter related to the third user command 1541 from the letters constituting the third text 1540. Accordingly, the display apparatus 200 may display a text 1540′ being edited such that at least a certain letter is deleted in connection with the third text 1540 in the quick memo execution UI screen.

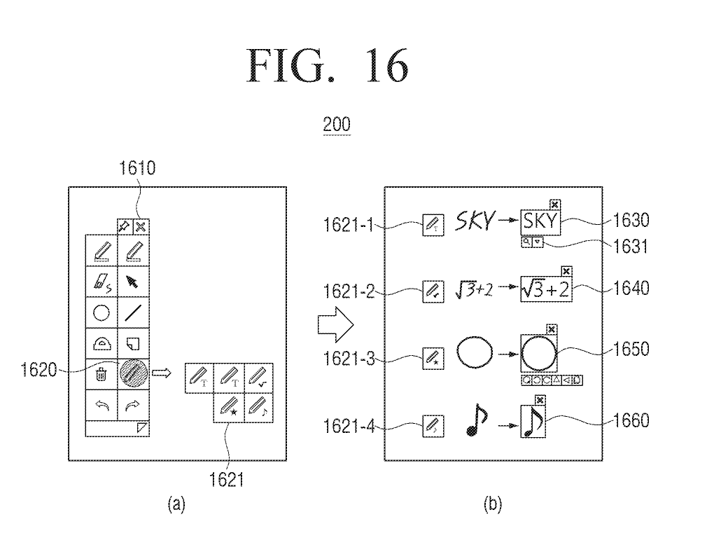

FIG. 16 is a third demonstration diagram provided to describe an operation of editing a quick memo in a quick memo execution UI environment of a display apparatus according to an exemplary embodiment.

As illustrated in FIG. 16(a), a first editing icon 1620 among a plurality of editing icons included in an editing tool 1610 for editing text may include a plurality of sub editing icons 1621. Accordingly, the display apparatus 200 may edit the text based on the sub editing icon 1621 selected from the plurality of sub editing icons 1621 included in the first editing icon 1620.

According to an exemplary embodiment, as illustrated in FIG. 16(b), in response to a user command to select a first letter being received while a selection command with respect to a first sub editing icon 1621-1 among the plurality of sub editing icons 1621 is received, the display apparatus 200 may perform an editing operation of converting the text letter into a predetermined format of text letter and display the edited text letter 1630 in the quick memo execution UI.

According to an exemplary embodiment, in response to a user command to select a number letter being received while a selection command with respect to a second sub editing icon 1621-2 among the plurality of sub editing icons 1621 is received, the display apparatus 200 may perform an editing operation of converting the number letter into a predetermined format of number letter and display the edited number letter 1640 in the quick memo execution UI screen.

According to an exemplar embodiment, in response to a user command to select a figure letter being received while a selection command with respect to a third sub editing icon 1621-3 among the plurality of sub editing icons 1621 is received, the display apparatus 200 may perform an editing operation of converting the figure letter into a predetermined format of figure and display the edited figure letter 1650 in the quick memo execution UI.

According to an exemplar embodiment, in response to a user command to select a symbol letter being received while a selection command with respect to a fourth sub editing icon 1621-4 among the plurality of sub editing icons 1621 is received, the display apparatus 200 may perform an editing operation of converting the symbol letter into a predetermined format of the symbol and display the edited symbol letter 1650 in the quick memo execution UI.

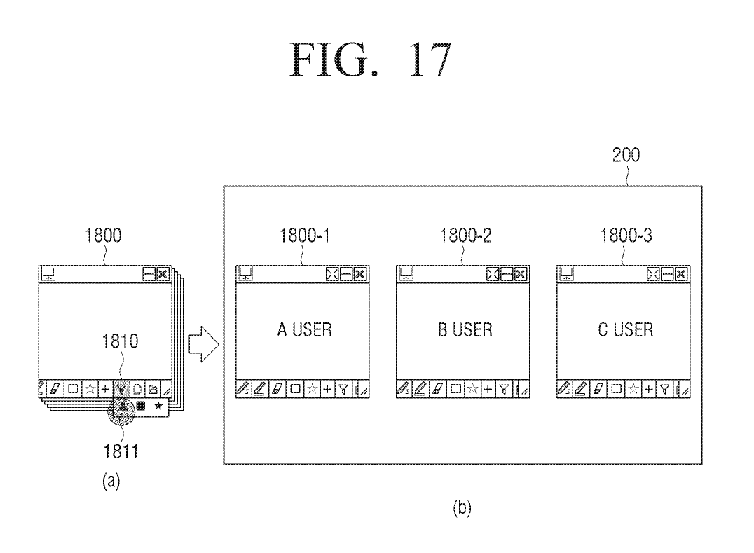

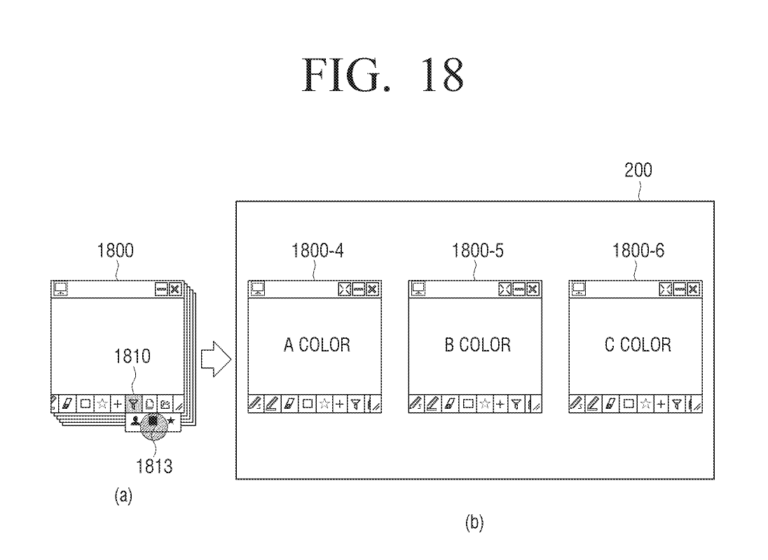

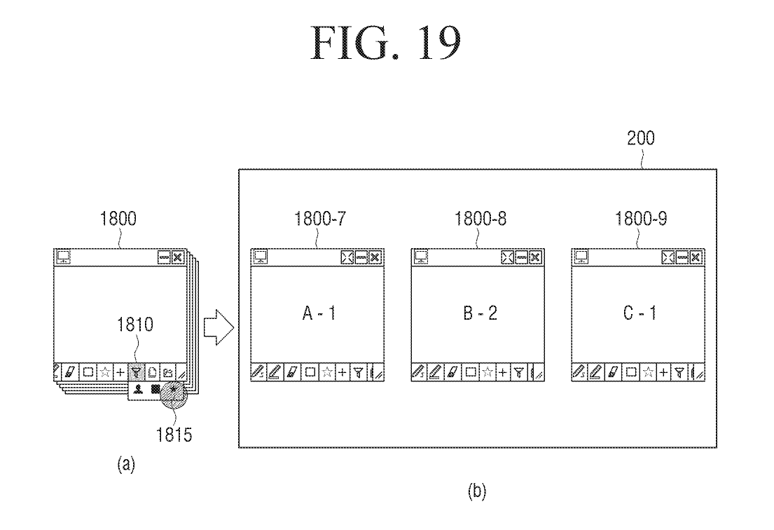

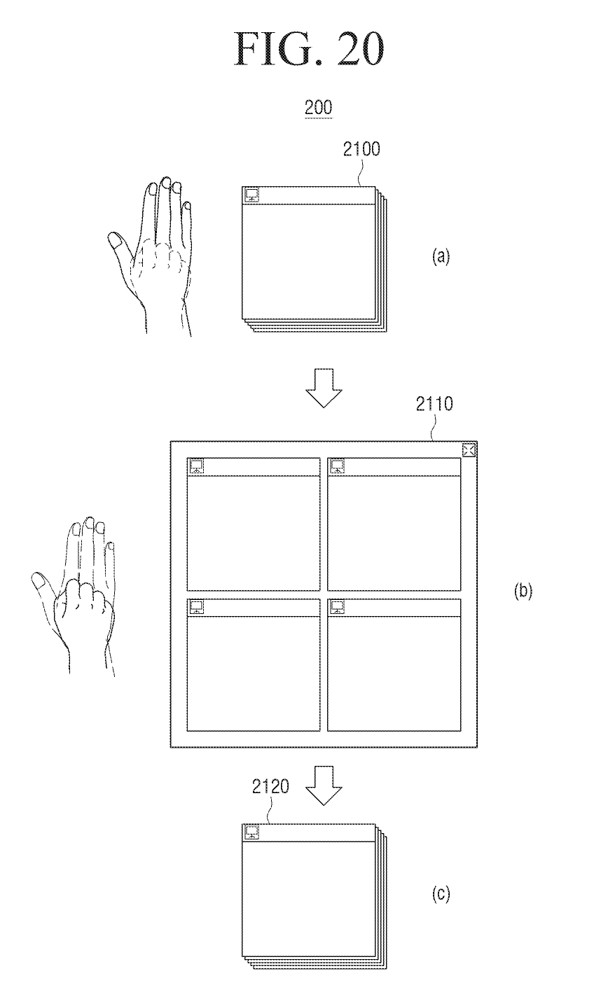

FIG. 17 is a first demonstration diagram provided to describe an operation of arranging a quick memo in a quick memo execution UI environment of a display apparatus according to an exemplary embodiment, FIG. 18 is a second demonstration diagram provided to describe an operation of arranging a quick memo in a quick memo execution UI environment of a display apparatus according to an exemplary embodiment, FIG. 19 is a third demonstration diagram provided to describe an operation of arranging a quick memo in a quick memo execution UI environment of a display apparatus according to an exemplary embodiment, and FIG. 20 is a fourth demonstration diagram provided to describe an operation of arranging a quick memo in a quick memo execution UI environment of a display apparatus according to an exemplary embodiment.

As illustrated in FIG. 17(a) to FIG. 19(a), in response to shared data related to the quick memo being received from the plurality of user terminals 100, the display apparatus 200 generates quick memo-related contents based on the plurality of received shared data and groups the plurality of generated contents as a group. Accordingly, the display apparatus 200 may display a group content 1800 where the plurality of contents have been grouped as a group in the quick memo execution UI. Furthermore, each of the contents may include an arranging tool 1810 for arranging a quick memo. In response to the arranging tool 1810 being selected, the display apparatus 200 may display a plurality of arranging icons related to the selected arranging tool 1810.

As illustrated in FIG. 17(a), a first arranging icon 1811 may be selected from among the plurality of arranging icons included in the arranging tool 1810. In this case, as illustrated in FIG. 17(b), the display apparatus 200 classifies the group content 1800 where the contents have been grouped as a group for each user based on the user information. Subsequently, the display apparatus 200 groups a first content 1800-1 classified as a content of the User A in a first group, groups a second content 1800-2 classified as a content of the User B in a second group, and groups a third content 1800-3 classified as a content of the User C in a third group. Accordingly, the display apparatus 200 may display the contents respectively being grouped as the first to third groups in the quick memo execution UI screen based on the user information.

As illustrated in FIG. 18(a), a second arranging icon 1813 may be selected from the plurality of arranging icons included in the arranging tool 1810. In this case, as illustrated in FIG. 18(b), the display apparatus 200 classifies the group content 1800 where the contents have been grouped as a group for each color based on color information. Subsequently, the display apparatus 200 groups the first content 1800-1 classified as a content of Color A in the first group, groups the second content 1800-2 classified as a content of Color B in the second group, and groups a third content 1800-3 classified as a content of Color C in the third group. Accordingly, the display apparatus 200 may display the contents respectively being grouped as the first to third groups in the quick memo execution UI screen based on the color information.

As illustrated in FIG. 19(a), a third arranging icon 1815 may be selected from among the plurality of arranging icons included in the arranging tool 1810. In this case, as illustrated in FIG. 19(b), the display apparatus 200 classifies the group content 1800 where the contents have been grouped as a group based on importance information set for each content. For example, a Content A-1 1800-7 of the User A, a Content B-2 1800-8 of the User B, and a Content C-1 1800-6 of the User C may be set as important contents included in the group content 1800 where the contents have been grouped as a group. Accordingly, the display apparatus 200 may display only the Content A-1 1800-7 of the User A, the Content B-2 1800-8 of the User B, and the Content C-1 1800-6 of the User C classified in the quick memo execution UI screen based on the importance information set for each content.

Meanwhile, as illustrated in FIG. 20(a), the display apparatus 200 may display a group content 2100 where a plurality of contents have been grouped as a group in the quick memo execution UI. The display apparatus 200 may receive a first user command from the user while the group content 2100 is displayed in the quick memo execution UI. In this case, the first user command may be a first gesture-operate command to move five fingers in an outward direction according to an exemplary embodiment. Accordingly, in response to the first gesture-operate command being received from the user, the display apparatus 200 may determine a region corresponding to each of the plurality of contents in the quick memo execution UI screen and display each content 2110 in the regions, as illustrated in FIG. 20(b).

Meanwhile, as illustrated in FIG. 20(b), the display apparatus 200 may receive a second user command from the user while each content is displayed in the quick memo execution UI screen. In this case, the second user command may be a second gesture-operate command to move five fingers in an inward direction according to an exemplary embodiment. Accordingly, in respond to the second gesture-operate command being received from the user, the display apparatus 200 may group the contents displayed in the quick memo execution UI screen as a group and display a group content 2120 in the quick memo execution UI screen, as illustrated in FIG. 20(c).

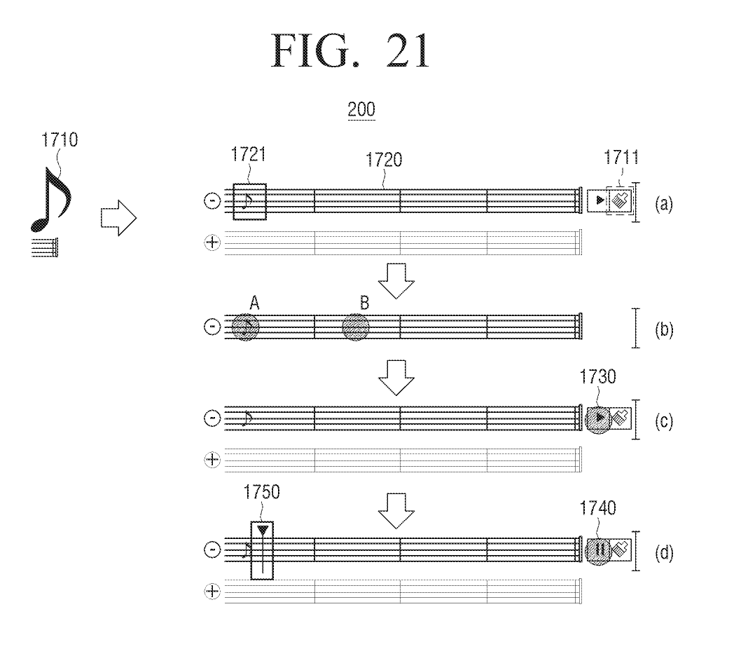

FIG. 21 is a demonstration diagram provided to describe an operation of providing a workspace UI environment in a display apparatus according to an exemplary embodiment.

The display apparatus 200 may display a workspace UI screen including a working tool for editing a content generated based on the shared data received from the user terminal 100 or generating a new content according to a user command.

For example, as illustrated in FIG. 21, the workspace UI screen may display a note-related symbol letter 1710 and an icon 1711 for generating a manuscript image to display the symbol letter 1710 in the vicinity of the symbol letter 1710.

In response to a user command being received while the symbol letter 1710 and the icon 1711 are displayed, the display apparatus 200 may generate a first icon 1730 for executing a manuscript content 1720 where a note 1721 is displayed in the manuscript content 1720 and display the generated first icon 1730 in the workspace UI, as illustrated in FIG. 21(a). In this case, as illustrated in FIG. 21(b), the display apparatus 200 may move the note 1721 displayed in the manuscript content 1720 to a measure region corresponding to the user command and display the note 1721. For example, the display apparatus 200 may move the note 1721 displayed in Measure region A of the manuscript content 1720 to Measure region B and display the note 1721.

As illustrated in FIG. 21(c), in response to the note 1721 being displayed in the measure region corresponding to the user command among a plurality of measure regions in the manuscript content 1720, the display apparatus 200 activates the first icon 1730 for executing the note 1721 displayed in the measure region. Accordingly, in response to a selection command with respect to the activated play icon 1730 being received, the display apparatus 200 may output an audio signal corresponding to the note 1721.

As illustrated in FIG. 21(d), the display apparatus 200 changes the first icon 1730 for executing the note 1721 to a second icon 1740 for stopping execution and display the second icon 1740 in the workspace UI screen while the audio signal corresponding to the note 1721 is outputted. Meanwhile, as illustrated in FIG. 21(d), in response to a selection command with respect to the second icon 1740 being received, the display apparatus 200 displays a play-tap icon 1750 next to the note 1721 corresponding to the audio signal outputted immediately before the selection command with respect to the second icon 1740 is received. In response to a selection command with respect to the play-tap icon 1750 being received while the play-tap icon 1750 is displayed, the display apparatus 200 may output an audio signal regarding a note displayed next to the play-tap icon 1750.

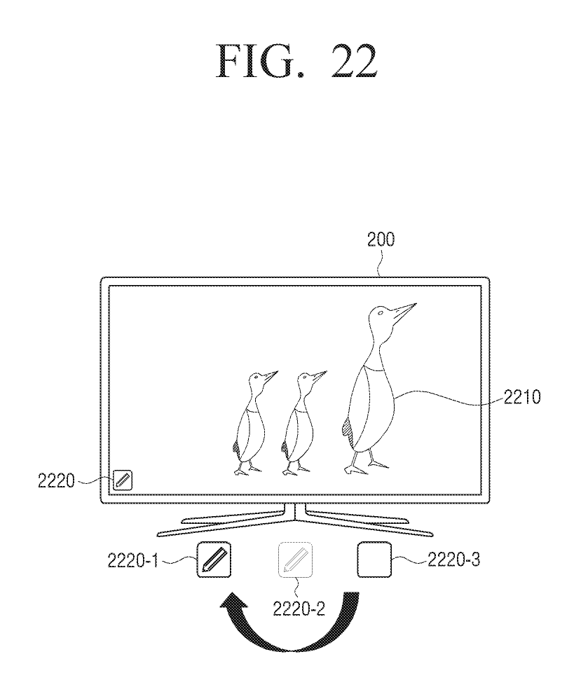

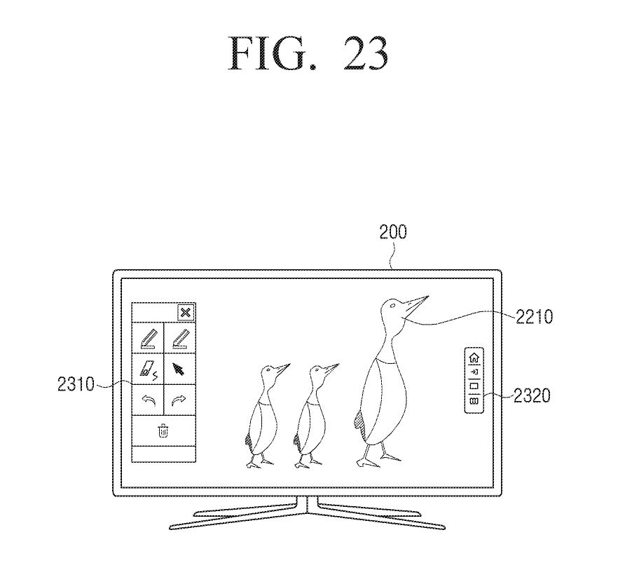

FIG. 22 is a first demonstration diagram provided to describe an operation of providing a working tool of a workspace UI in an external source input environment of a display apparatus according to an exemplary embodiment, and FIG. 23 is a second demonstration diagram provided to describe an operation of providing a working tool of a workspace UI in an external source input environment of a display apparatus according to an exemplary embodiment.

As illustrated in FIG. 22, in response to a user command being received while the workspace UI screen is displayed, the display apparatus 200 may receive an image signal corresponding to the received user command from outside and display an image content 2210 regarding the received image signal. In this case, the display apparatus 200 may display a working tool icon 2220 provided from the workspace UI screen in a certain region of the screen where the image content 2210 is displayed.

In response to a selection command with respect to the working tool icon 2220 being received while the working tool icon 2220 is displayed, the display apparatus 200 may display a first working tool bar 2310 for editing and generating a content in one region of the screen where the image content is displayed and display a second working tool bar 2320 for converting a mode in other region of the screen, as illustrated in FIG. 23.

Referring to FIG. 22, the display apparatus 200 determines whether a user command with respect to the working tool icon 2220 is received within a predetermined time while the image content 2210 is displayed. In response to determining that a user command with respect to the working tool icon 2220 is not received with in the predetermined time, the display apparatus 200 deletes the working tool icon 2220 from the screen where the image content 2210 is displayed. In response to determining that the user command is received in a state where the working tool icon 2220 has been deleted, the display apparatus 200 may bring back and display the deleted working tool icon 2220 in the region.

According to an exemplary embodiment, as illustrated in FIG. 22, in response to the user command with respect to the working tool icon 2220 being received within the predetermined time, the display apparatus 200 may display the working tool icon 2220 in the screen while maintaining resolution of the working tool icon 2220 in predetermined first resolution (for example, the resolution of the icon 2220-1). Meanwhile, in response to the user command with respect to the working tool icon 2220 not being received with in a predetermined first critical time, the display apparatus 200 may display the working tool icon 2220 by changing the resolution of the working tool icon 2220 to second resolution (for example, the resolution of the icon 2220-2) lower than the first resolution.

In response to the user command with respect to the working tool icon 2220 being received within a predetermined second critical time while the working tool icon 2220 in the second resolution is displayed in the screen, the display apparatus 200 may display the working tool icon 2220 in the screen by increasing the second resolution to the first resolution higher than the second resolution.

In response to the user command with respect to the working tool icon 2220 not being received within the predetermined second critical time while the working tool icon 2220 is displayed in the second resolution, the display apparatus 200 may change the second resolution of the working tool icon 2220 to resolution where the working tool bar 2220 is deleted from the screen (for example, the resolution of the icon 2220-3). Accordingly, the display apparatus 200 may display only the image content 2210 in the screen.

As described above, in response to the user command being received while only the image content is displayed in the screen, the display apparatus 200 changes the resolution of the working tool icon 2220 to the first resolution. Accordingly, the display apparatus 200 may display the working tool icon 2220 in the first resolution in one region of the screen where the image content 2210 is displayed.

Hereinafter, an operation of providing diverse execution UI environments in the display apparatus 200 will be described in detail according to an embodiment.

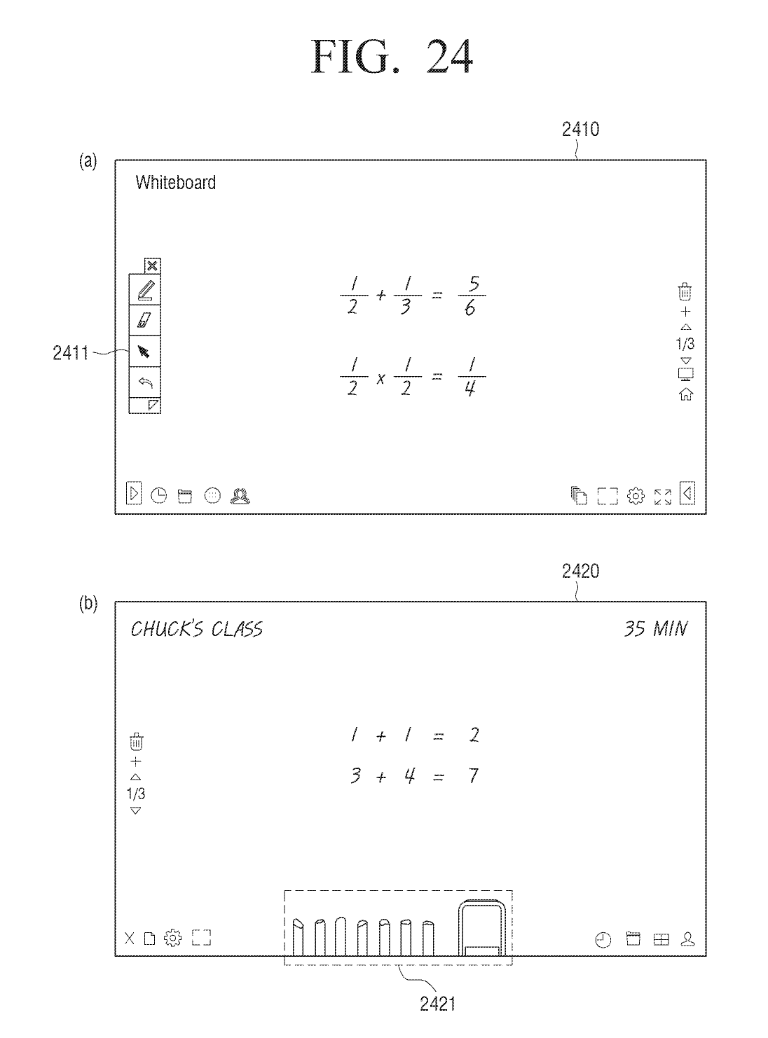

FIG. 24 is a demonstration diagram provided to describe an operation of providing a board writing execution UI environment in a display apparatus according to an exemplary embodiment.

In a class environment, the display apparatus 200 may display a first board writing execution UI 2410 in a form of a white board as illustrated in FIG. 24(a) or display a second board writing execution UI 2420 in a form of a chalk board as illustrated in FIG. 24(b). The first and second board writing execution UIs 2410 and 2420 may include board writing tool elements 2411 and 2421 for a board writing operation. According to an exemplary embodiment, the board writing tool elements 2411 and 2421 may be an icon in a form of a text or an image.

To be specific, in response to the first board writing execution UI 2410 in the form of the White Board being executed, the display apparatus 200 may display the board writing tool element 2411 including a board marker-shaped icon used in a white board and an eraser icon for deleting the words written on the first board writing execution UI 2410 in the first board writing execution UI 2410.

In response to the second board writing execution UI 2420 in the form of the chalk board being executed, the display apparatus 200 may display the board writing tool element 2421 including a chalk-shaped icon used in a chalk board and an eraser icon 2421 for deleting the words written on the second board writing execution UI 2420 in the second board writing execution UI 2420.

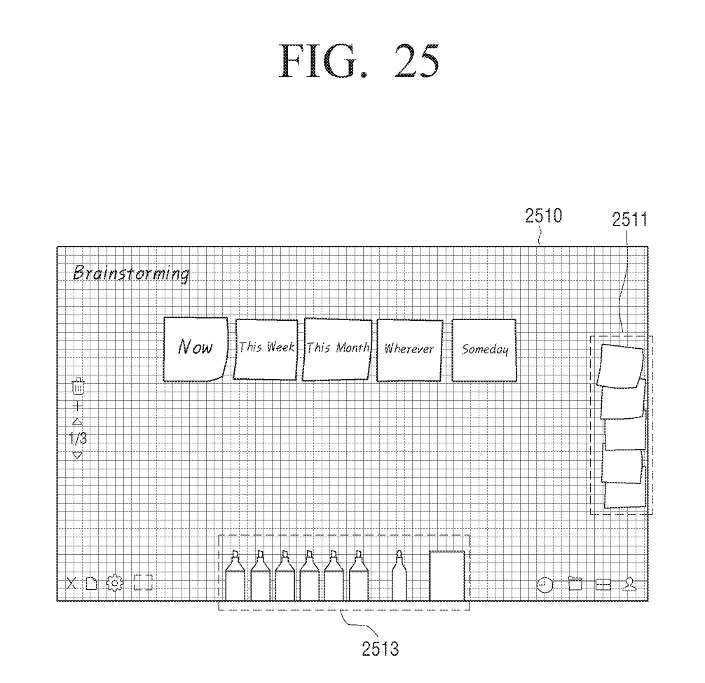

FIG. 25 is a demonstration diagram provided to describe an operation of providing an office UI environment in a display apparatus according to an exemplary embodiment.

As illustrated in FIG. 25, when a brainstorming session with respect to a particular subject is carried out in an office environment, the display apparatus 200 may display an office UI 2510 according to a user command. The office UI 2510 may include working tool elements 2511 and 2513 regarding tools used in the brainstorming session. According to an exemplary embodiment, the first working tool element 2511 may include an image icon in a form of an adhesive notepad for briefly recording a result of the brainstorming session, and the second working tool element 2511 may include an image icon in a form of a writing instrument for recording the result of the brainstorming session in the image icon in the form of the adhesive notepad.

Accordingly, the user may select at least one of image icons included in the first working tool element 2511 and record the result of the think session on the selected image in the form of the notepad selected by using a pen selected from the second working tool element 2513.

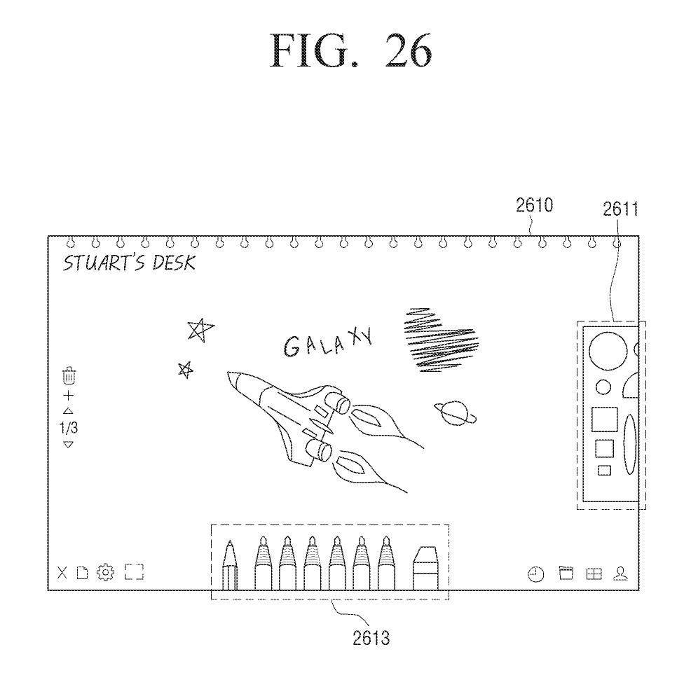

FIG. 26 is a demonstration diagram provided to describe an operation of providing a picture board UI environment in a display apparatus according to an exemplary embodiment.

As illustrated in FIG. 26, the display apparatus 200 may display a picture board UI 2610 in a form of a drawing paper for drawing a picture according to a user command. The picture board UI 2610 may include picture working tool elements 2611 and 2613 regarding tools necessary for drawing a picture. According to an exemplary embodiment, the first picture working tool element 2611 may include a figure icon for drawing various figures, and the second working tool element 2613 may include a picture tool icon, such as a colored pencil for drawing a picture on the picture board UI 2610.

Accordingly, the user is able to draw a desired figure on the picture board UI 2610 by using the figure icon included in the first picture working tool element 2611 or draw a picture on the picture board UI 2610 by using a colored pencil selected from the second working tool element 2613.

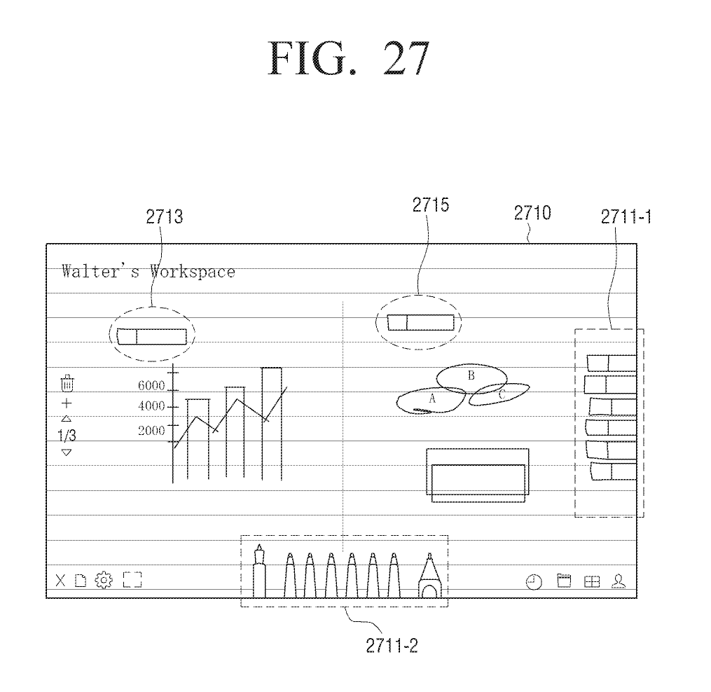

FIG. 27 is a demonstration diagram provided to describe an operation of providing a note UI environment in a display apparatus according to an exemplary embodiment.

As illustrated in FIG. 27, for example, in the class environment, the display apparatus 200 may display a note UI 2710 according to a user command. The note UI 2710 may include a writing working tool element 2711 for note writing. According to an embodiment, a first writing working tool element 2711-2 may include a writing tool icon for the note writing, and a second writing working tool element 2711-1 may include a page marker icon which performs a bookmark function for displaying the importance of writing or retrieving the writing.

Accordingly, the user is able to write a document on the note UI 2710 by using the writing tool icon included in the first writing working tool element 2711-2. In response to the UI screen where the document writing has been completed including important substance, the user is able to display pre-selected page marker icons 2713 and 2715 in the UI screen by using the page marker icon included in the second working tool element 2711-1.

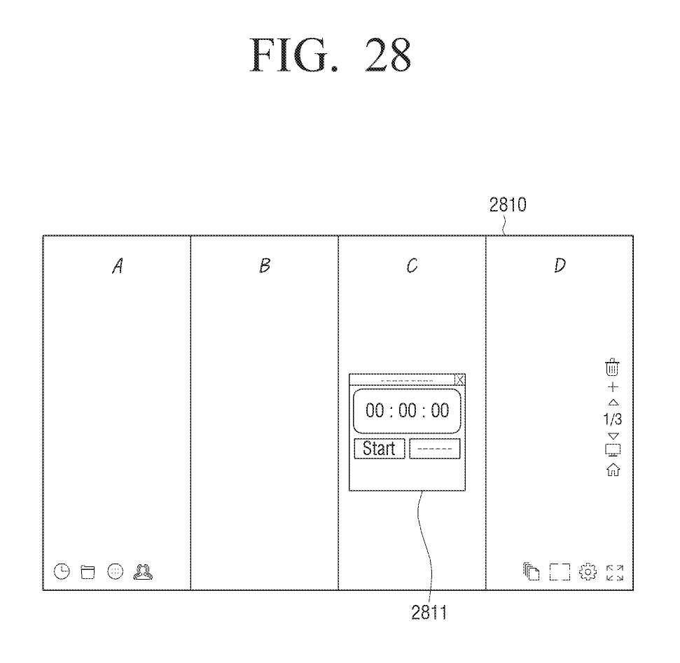

FIG. 28 is a demonstration diagram provided to describe an operation of providing a UI environment for user participation in a display apparatus according to an exemplary embodiment.

For example, when a quiz session is carried out in the class environment, the display apparatus 200 may display a member participation UI 2810 for participation of members in the class according to a user command. The member participation UI 2810 has as screen which is split to correspond to each of Members A to D who participate in the quiz session, and a timer element 2811 for showing time for resolving a quiz question may be displayed in a certain region of the UI screen.

Accordingly, each of the Members A to D who participate in the quiz session transmits result information on the quiz question to the display apparatus 200 by using the user terminal 100. Accordingly, the display apparatus 200 may display the result information on the quiz question received from the user terminal 100 of a member who transmitted the result information within a time provided through the timer element 2811 in a region corresponding to the member, among the user terminals 100 of the Members A to D.

Hereinafter, a method for controlling an operation of the user terminal 100 and the display apparatus 200 will be described in detail.

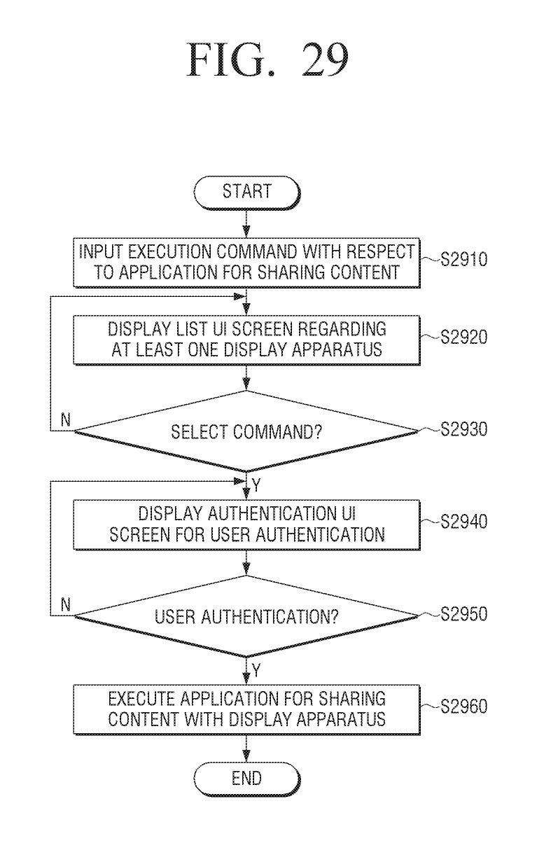

FIG. 29 is a flowchart provided to describe a method for connecting a display apparatus for data communication in a user terminal according to an exemplary embodiment.

As illustrated in FIG. 29, the user terminal 100 performs data communication with the display apparatus 200 to receive an application execution command with respect to an application for sharing a content in operation S2910. In response to the application execution command being received, the user terminal 100 executes an “Agent App”-related application. In response to the “Agent App”-related application being executed, the user terminal 100 searches for the display apparatus 200 that is capable of performing the data communication with the user terminal 100 and displays a list UI screen regarding the plurality of searched display apparatuses 200 in operation S2920.

In response to a selection command with respect to one display apparatus 200 being received while the list UI screen is displayed, the user terminal 100 displays a user authentication UI screen for user authentication in operations S2930 and S2940. According to an embodiment, the user terminal 100 may display a user authentication UI screen for inputting a user's name and e-mail information.

In response to the user information including the user's name and e-mail information being received from the user while the user authentication UI screen is displayed, the user terminal 100 performs user authentication based on the received user information in operation S2950. In response to the user authentication being completed, the user terminal 100 performs the data communication with the display apparatus 200 selected by the user and executes an application for sharing a content in operation S2960. That is, in response to the user authentication being completed, the user terminal 100 may display an “Agent App” application execution UI screen.

In response to the “Agent App” application execution UI screen being displayed, the user may transmit shared data to the display apparatus 200 selected by the user through his/her own user terminal 100 or receive and display a UI screen including a content related to the shared data transmitted to the display apparatus 200 by other user's user terminal 100.

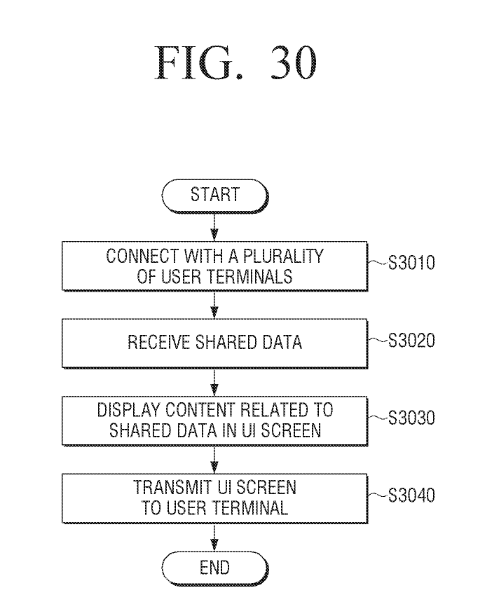

FIG. 30 is a flowchart provided to describe a method for controlling a display apparatus having a large-screen display according to an exemplary embodiment.

As illustrated in FIG. 30, the display apparatus 200 performs connection with a plurality of user terminals 100. In response to the connection with the plurality of user terminals 100 being performed, the display apparatus 200 receives shared data from at least one user terminal 100 among the plurality of connected user terminals 100 in operations S3010 and S3020. In response to the shared data being received from the at least one user terminal 100, the display apparatus 200 displays a content related to the received shared data in a UI screen in operation S3030. In response to a user command being received while the UI screen is displayed, the display apparatus 200 may edit the content displayed in the UI screen and display the edited content in the UI screen.

The display apparatus 200 transmits the UI screen including the content or the UI screen including the edited content to the user terminal 100 according to a user command in operation S3040. Accordingly, the user terminal 100 may display the UI screen received from the display apparatus 200.

In the above-described operation S3030, in response to a user command being received from the at least one user terminal 100 among the plurality of user terminals 100, the display apparatus 200 may display various UI screens based on the received user command.

According to an exemplary embodiment, the display apparatus 200 may display the content related to the shared data received from the at least one user terminal 100 to a UI for sharing a content and providing a community environment. In this case, the community UI may include a region corresponding to the at least one user terminal 100. Accordingly, the display apparatus 200 may display the content related to the shared data received from the at least one user terminal 100 and user information on the region corresponding to the at least one user terminal 100.

The community UI may include at least one of a Poll UI for user participation regarding the content related to the shared data received from the at least one user terminal 100, a Social UI for sharing a user opinion on a preregistered subject, and a Social Bookmark UI for sharing information on the preregistered subject.

According to an exemplary embodiment, in response to a user command being received from at least one user terminal among the plurality of user terminals 100, the display apparatus 200 may display a quick memo execution UI screen for sharing and editing a quick memo related to the shared data received from the at least one user terminal 100. In this case, the quick memo execution UI may include an editing tool for editing the quick memo. Accordingly, the display apparatus 200 may edit the quick memo included in the quick memo execution UI screen according to an execution command with respect to the editing tool included in the quick memo execution UI.

The quick memo execution UI may further include an arranging tool for arranging a quick memo. Accordingly, in response to receiving a first execution command among execution commands with respect to the arranging tool included in the quick memo execution UI, the display apparatus 200 groups a plurality of quick memos included in the quick memo execution UI screen. In response to receiving a second execution command among the execution commands with respect to the arranging tool included in the quick memo execution UI, the display apparatus 200 may filter the plurality of quick memos based on an arrangement condition corresponding to the second execution command.

In addition, the quick memo execution UI may include regions for respectively displaying the plurality of quick memos. In this case, in response to a predetermined first gesture-operate command being received, the display apparatus 200 displays each of the plurality of quick memos in the regions included in the quick memo execution UI screen. In response to a predetermined second gesture-operate command being received, the display apparatus 200 may group the quick memos and display the grouped quick memos displayed in the regions included in the quick memo execution UI as a quick memo set.

According to an exemplary embodiment, the display apparatus 200 may display a workspace UI screen including a working tool for editing and generating a content according to a user command. In response to a user command being received while the workspace UI screen is displayed, the display apparatus 200 may display an image content received from outside. In this case, the display apparatus 200 displays the working tool included in the workspace UI in a certain region where the image content is displayed. Meanwhile, the display apparatus 200 determines whether a user command with respect to the working tool is received within a predetermined time. In response to determining that the user command with respect to the working tool is not received within the predetermined time, the display apparatus 200 deletes the working tool from the screen where the image content is displayed. In response to determining that the user command is received in a state where the working tool has been deleted, the display apparatus 200 may bring back and display the deleted working tool in the screen where the image content is displayed.

The display apparatus and control method according to various exemplary embodiments described above may be implemented in a program to be provided to the display apparatus. Particularly, the program including the portable terminal apparatus and control method may be stored and provided in a non-transitory computer readable medium.

The non-transitory computer readable medium does not mean a medium storing data for a short period such as a register, a cash, a memory, or the like, but means a machine-readable medium semi-permanently storing the data. Specifically, various applications or programs described above may be stored and provided in the non-transitory computer readable medium such as a compact disc (CD), a digital versatile disk (DVD), a hard disk, a Blu-ray disk, a universal serial bus (USB), a memory card, a read-only memory (ROM), or the like.

As above, a few embodiments have been shown and described. The foregoing embodiments and advantages are merely exemplary and are not to be construed as limiting the present inventive concept. The present teaching can be readily applied to other types of devices. Also, the description of the embodiments is intended to be illustrative, and not to limit the scope of the claims, and many alternatives, modifications, and variations will be apparent to those skilled in the art.

What is claimed is:

1. A method for controlling a display apparatus having a display, the method comprising:
establishing connections with a plurality of user terminals;
receiving, in response to establishing the connections, shared data from at least one user terminal among the plurality of user terminals;
displaying content related to the shared data received from the at least one user terminal in a User Interface (UI) on the display of the display apparatus; and
editing the content and displaying the edited content in the UI in response to receiving a user command.

2. The method as claimed in claim 1, further comprising:
transmitting the UI including the content to the at least one user terminal, wherein the at least one user terminal displays the UI including the content.

3. The method as claimed in claim 1, wherein the user interface is a community UI, and the community UI is configured to share the content and provide a community environment.

4. The method as claimed in claim 3, wherein the community UI comprises a region corresponding to the at least one user terminal, and wherein the displaying comprises displaying the content related to the shared data received from the at least one user terminal and user information corresponding to the at least one user terminal in the region.

5. The method as claimed in claim 3, wherein the community UI comprises at least one of a Poll UI, a social UI, and a Social Bookmark UI, and wherein the Poll UI is configured to allow a user to share an opinion of the user regarding the content, a Social UI is configured to share a user opinion on a preregistered subject, and a Social Bookmark UI is configured to share information on the preregistered subject.

6. The method as claimed in claim 1, wherein the user interface is a quick memo execution UI, and the quick memo execution UI is configured to share and edit a quick memo related to the shared data received from the at least one user terminal.

7. The method as claimed in claim 6, wherein the quick memo execution UI comprises an editing tool for editing the quick memo, and wherein the editing comprises editing the quick memo included in the screen of the quick memo execution UI according to an execution command with respect to the editing tool.

8. The method as claimed in claim 7, wherein the editing tool comprises an arranging tool for arranging the quick memo, and wherein in response to a first execution command with respect to receiving the arranging tool, the editing comprises grouping a plurality of quick memos included in the screen of the quick memo execution UI, and in response to receiving a second execution command, filtering the plurality of quick memos based on an arrangement condition corresponding to the second execution command.

9. The method as claimed in claim 6, wherein the quick memo execution UI comprises regions for respectively displaying a plurality of quick memos, wherein in response to receiving a predetermined first user command, the displaying comprises displaying the plurality of quick memos in the regions included in the screen of the quick memo execution UI, and in response to receiving a predetermined second user command, grouping and displaying the plurality of quick memos displayed in the regions as a quick memo set.

10. The method as claimed in claim 1, wherein the user interface is a workspace UI including a working tool for editing the content and generating a content according to a user command, wherein in response to receiving a user command while displaying the workspace UI, the displaying further comprises displaying an image content received from outside, and wherein the displaying the image content comprises displaying the working tool in a certain region where the image content is displayed and deleting the working tool from the screen where the image content is displayed or bringing back and displaying the deleted working tool in the screen according to whether a user command with respect to the working tool is received within a predetermined time.

11. A display apparatus comprising:
a communicator configured to receive shared data from at least one user terminal among a plurality of user terminals in communication with the display apparatus;
a display configured to display content related to the received shared data in a User Interface (UI); and
a controller configured to receive a user command and, in response to receiving a user command, control the display to edit the content and display the edited content in the UI.

12. The display apparatus as claimed in claim 11, wherein the controller is further configure to control the communicator to transmit the UI including the edited content to the at least one user terminal, and wherein the at least one user terminal displays the UI including the content.

13. The display apparatus as claimed in claim 11, wherein the user interface is a community UI, and the community UI is configured to provide a community environment and display the content.

14. The display apparatus as claimed in claim 13, wherein the community UI comprises a region corresponding to the at least one user terminal, and the controller is further configured to control the display to display the content related to the shared data received from the at least one user terminal and user information corresponding to the at least one user terminal in the region.

15. The display apparatus as claimed in claim 13, wherein the community UI comprises at least one of a Poll UI, a Social UI, and a Social Bookmark UI, and wherein the Poll UI is configured to allow a user to share an opinion of the user regarding the content related to the shared data received from the at least one user terminal, the Social UI is configured to share a user opinion on a preregistered subject, and the Social Bookmark UI is configured to share information on the preregistered subject.

16. The display apparatus as claimed in claim 11, wherein the user interface is a quick memo execution UI, and the quick memo execution UI is configured to share and edit a quick memo related to the shared data received from the at least one user terminal.

17. The display apparatus as claimed in claim 16, wherein the quick memo execution UI comprises an editing tool for editing the quick memo, and wherein the controller is further configured to edit the quick memo included in the screen of the quick memo execution UI according to an execution command with respect to the editing tool.

18. The display apparatus as claimed in claim 17, wherein the editing tool comprises an arranging tool for arranging the quick memo, and wherein the controller is further configured to group a plurality of quick memos included in the screen of the quick memo execution UI in response to receiving a first execution command with respect to the arranging tool, and is further configured to filter the plurality of quick memos based on an arrangement condition corresponding to a second execution command in response to receiving the second execution command.

19. The display apparatus as claimed in claim 16, wherein the quick memo execution UI comprises regions for respectively displaying the plurality of quick memos, and wherein the controller is further configured to control the display to display the plurality of quick memos in the regions included in the screen of the quick memo execution UI in response to receiving a predetermined first user command and is further configured to group and display the plurality of quick memos displayed in the regions as a quick memo set in response to receiving a predetermined second user command.

20. The display apparatus as claimed in claim 11, wherein the user interface is a workspace UI including a working tool for editing the content and generating a content according to a user command, and wherein in response to receiving a user command being received while the workspace UI is displayed, the controller is further configured to control the display to display an image content received from outside and the working tool, and wherein the controller is further configured to control the display to delete the working tool from the screen where the image content is displayed or bring back and display the deleted working tool in the screen according to whether a user command with respect to the working tool is received within a predetermined time while the image content is displayed.
